(19) United States
(12) Patent Application Publication
(10) Pub. No.: US 2013/0284637 A1
(43) Pub. Date: Oct. 31, 2013

(54) UNIT-DOSE FORMAT PERHYDROLASE SYSTEMS

(71) Applicant: DANISCO US INC., Palo Alto, CA (US)

(72) Inventors: Grace Chou, Mountain View, CA (US); Ayrookaran J. Poulose, Belmont, CA (US)

(21) Appl. No.: 13/791,749

(22) Filed: Mar. 8, 2013

Related U.S. Application Data
(60) Provisional application No. 61/640,614, filed on Apr. 30, 2012.

(51) Int. Cl. C11D 17/04; C11D 3/386

(52) U.S. Cl. CPC C11D 17/045; C11D 3/38636
USPC 206/568

(57) ABSTRACT

Described are compositions and methods relating to unit-dose format perhydrolase enzyme systems for use in cleaning applications, such as laundry and dishwashing.

### PRIORITY

The present application claims priority to U.S. Provisional Patent Application Ser. No. 61/640,614, filed on Apr. 30, 2012, which is hereby incorporated by reference in its entirety

### TECHNICAL FIELD

The present compositions and methods relate to unit-dose format perhydrolase enzyme systems for use in cleaning applications, such as laundry and dishwashing.

### BACKGROUND

Perhydrolases are enzymes capable of catalyzing a perhydrolysis reaction that results in the production of peracids from a carboxylic acid ester (acyl) substrate and a peroxide source. Although many hydrolytic enzymes are capable of background levels of perhydrolysis activity only a handful of robust perhydrolase enzymes have been identified. These enzymes preferentially perform perhydrolysis over hydrolysis, making them well suited for use in generating peracids for cleaning, bleaching, and disinfection applications.

One difficulty with using a perhydrolase enzyme system to produce peracids in consumer cleaning products is the need to provide the components of the system, i.e., the perhydrolase enzyme, an acyl substrate, and source of peroxygen, in a stable form suitable for storage, while making it easy for the consumer to combine the components of the system to initiate peracid production.

The present compositions and methods address the problem of storing and combining the components of the perhydrolase enzyme system and further address the problem of combining a perhydrolase enzyme system with conventional laundry and dishwashing detergents.

### SUMMARY

Aspects and embodiments of the present compositions and methods are set forth in the following numbered paragraphs:

1. In one aspect, a unit-dose package for delivering a perhydrolase enzyme system in a cleaning application is provided, the perhydrolase enzyme system comprising a perhydrolase enzyme component, an acyl substrate component, and a peroxide source component, the package comprising: a first compartment at least partially bounded by a water-soluble material and comprising a first component of the perhydrolase enzyme system; a second compartment at least partially bounded by a water-soluble material and comprising a second component and a third component of the perhydrolase enzyme system; wherein the first component in the first compartment and the second and third components in the second compartment are separated during storage to prevent the formation of peracids, and wherein upon dissolution in an aqueous solution the first compartment and second compartment dissolve simultaneously or sequentially to permit contact of the first, second, and third components of the perhydrolase enzyme system to generate peracid.

2. In some embodiments of the unit-dose package of paragraph 1, the first component is the perhydrolase enzyme, the second component is the acyl substrate, and the third component is the peroxide source.

3. In some embodiments of the unit-dose package of paragraph 1, the first component is the acyl substrate, the second component is the perhydrolase enzyme, and the third component is the peroxide source.

4. In some embodiments of the unit-dose package of paragraph 1, the first component is the peroxide source, the second component is the acyl substrate, and the third component is the perhydrolase enzyme.

5. In some embodiments of the unit-dose package of paragraph 1, a very low-water, non-aqueous, or non-mixing form of laundry or dishwashing detergent is additionally provided in the first compartment.

6. In some embodiments of the unit-dose package of paragraph 5, the first component is a perhydrolase enzyme provided in liquid or solid form, the second component is an acyl substrate provided in non-aqueous liquid form, and the third component is a peroxide source provided in solid form.

7. In some embodiments of the unit-dose package of paragraph 5, the first component is an acyl substrate provided in non-aqueous liquid form, the second component is a perhydrolase enzyme provided in solid or non-aqueous liquid form, and the third component is the peroxide source provided in solid form.

8. In some embodiments of the unit-dose package of paragraph 5, the first component is a peroxide source provided in solid form, the second component is an acyl substrate provided in non-aqueous liquid form, and the third component is a perhydrolase enzyme provided in solid or non-aqueous liquid form.

9. In some embodiments of the unit-dose package of paragraphs 5-8, the laundry or dishwashing detergent is provided as a non-mixing form selected from the group consisting of a solid, a gel, a paste, or a wax.

10. In some embodiments of the unit-dose package of paragraphs 5-8, the laundry or dishwashing detergent is provided as a very low-water liquid having a water content of less than about 10%.

11. In some embodiments of the unit-dose package of paragraphs 5-8, the laundry or dishwashing detergent is non-aqueous.

12. In some embodiments of the unit-dose package of paragraph 1, a very low-water, non-aqueous, or non-mixing form of laundry or dishwashing detergent is additionally provided in the second compartment.

13. In some embodiments of the unit-dose package of paragraph 12, the first component is a perhydrolase enzyme provided in solid or liquid form, the second component is an acyl substrate provided in non-aqueous form, and the third component is a peroxide source provided in solid form.

14. In some embodiments of the unit-dose package of paragraph 12, the first component is acyl substrate provided in liquid form, the second component is a perhydrolase enzyme provided in solid or non-aqueous liquid form, and the third component is a peroxide source provided in solid form.

15. In some embodiments of the unit-dose package of paragraph 12, the first component is a peroxide source provided in solid or liquid form, the second component is an acyl substrate provided in non-aqueous liquid form, and the third component is a perhydrolase enzyme provided in solid or non-aqueous liquid form.

16. In some embodiments of the unit-dose package of paragraphs 12-15, the laundry or dishwashing detergent is provided as a non-mixing form selected from the group consisting of a solid, a gel, a paste, or a wax.

17. In some embodiments of the unit-dose package of paragraphs 12-15, the laundry or dishwashing detergent is provided as a very low-water liquid having a water content of less than about 10%.

18. In some embodiments of the unit-dose package of paragraphs 12-15, the laundry or dishwashing detergent is non-aqueous.

19. In some embodiments of the unit-dose package of any of the preceding paragraphs, the first compartment is completely bounded by a water-soluble material.

20. In some embodiments of the unit-dose package of any of the preceding paragraphs, the second compartment is completely bounded by a water-soluble material.

21. In some embodiments of the unit-dose package of any of the preceding paragraphs, the first compartment is the water-soluble material bounding the second compartment.

22. In some embodiments of the unit-dose package of any of the preceding paragraphs, the second compartment is the water-soluble material at least partially bounding the first compartment.

23. In some embodiments of the unit-dose package of any of the preceding paragraphs, the first compartment is a film applied to the water-soluble material bounding the second compartment.

24. In some embodiments of the unit-dose package of any of the preceding paragraphs, the second compartment is a film applied to the water-soluble material bounding the first compartment.

25. In some embodiments the unit-dose package of any of the preceding paragraphs further comprises an additional compartment.

26. In some embodiments of the unit-dose package of paragraph 25, the additional compartment comprises a laundry detergent composition, a dishwashing detergent composition, a fabric softener, or a rinsing agent.

27. In some embodiments of the unit-dose package of any of the preceding paragraphs, the peroxide source component is and oxidase enzyme and a substrate for the oxidase enzyme, wherein the activity of the oxidase enzyme on the substrate produces peroxide.

28. In some embodiments of the unit-dose package of any of paragraph 27, the oxidase enzyme and substrate for the oxidase enzyme are present in different compartments.

29. In another aspect, a unit-dose package comprising a water-soluble pouch and a detergent composition is provided, the pouch comprising at least a first compartment and a second compartment, the detergent composition comprising: (a) from about 5% to about 80% by weight of a surfactant; (b) from about 1% to about 15% by weight of non-aqueous solvent; (c) less than 10% by weight of water; and (d) a perhydrolase enzyme system comprising (i) a perhydrolase enzyme, (ii) an acyl substrate, and (iii) a peroxide source; wherein at least one component selected from (i), (ii), or (iii) is separated from at least one other component selected from (i), (ii), or (iii) by being present in different compartments of the pouch.

30. In some embodiments, the unit-dose package of paragraph 29 comprises at least a first compartment, a second compartment, and a third compartment, wherein each component selected from (i), (ii), or (iii) is separated from each other component by being present in a different compartment of the pouch.

31. In some embodiments of the unit-dose package of preceding paragraphs 29 or 30, the detergent composition further comprises an additional component selected from the group consisting of a chelant, a polymer, a brightener, a fragrance, and a process aid.

32. In some embodiments of the unit-dose package of preceding paragraphs 29-31, the detergent composition further comprises one or more additional enzymes other than the perhydrolase.

33. In some embodiments of the unit-dose package of preceding paragraphs 29-32, the surfactant is an anionic surfactant, a non-ionic surfactant, or combinations thereof.

34. In another aspect, a unit-dose package comprising a water-soluble pouch and a detergent composition is provided, the pouch comprising at least a first compartment and a second compartment, the detergent composition comprising: (a) a non-phosphorus builder; (b) a chelating agent; (c) a perhydrolase enzyme system comprising a perhydrolase enzyme, an acyl substrate, and a peroxide source; wherein at least two components of the perhydrolase enzyme system are present in different compartments of the pouch.

35. In some embodiments of the unit-dose package of paragraph 34, the detergent composition further comprises a cleaning enzyme selected from the group consisting of a protease and an alpha-amylase.

36. In some embodiments, the unit-dose package of paragraphs 34 or 35 further comprises a rinse aid.

37. In another aspect, methods of using the unit dose packages of any of the preceding claims to clean laundry, dishes, toilets, sinks, driveways, decking, and other surfaces is provided.

These and other aspects and embodiments of present compositions and methods will be further apparent from the description.

### BRIEF DESCRIPTION OF THE DRAWINGS

FIG. 1 illustrates an embodiment of the unit-dose package that includes a single compartment that is at least partially bounded by a water-soluble material.

FIG. 2 illustrates an embodiment of the unit-dose package that includes a single compartment in which components of the perhydrolase system are suspended or dispersed in a water-soluble material.

FIG. 3 illustrates an embodiment of the unit-dose package that includes two compartments, wherein the perhydrolase enzyme is provided in the first compartment and the acyl substrate and peroxide source are provided in the second compartment.

FIG. 4 illustrates an embodiment of the unit-dose package that includes two compartments, wherein the acyl substrate is provided in the first compartment and the perhydrolase enzyme and peroxide source are provided in the second.

FIG. 5 illustrates an embodiment of the unit-dose package that includes two compartments, wherein the peroxide source is provided in the first compartment and the acyl substrate and perhydrolase enzyme are provided in the second compartment.

FIG. 6 illustrates an embodiment of the unit-dose package that includes two compartments, wherein one compartment contains components of the perhydrolase system suspended or dispersed in a water-soluble material and the other compartment is at least partially bounded by water-soluble material.

FIG. 7A illustrates an embodiment of the unit-dose package that includes two compartments, wherein one compartment is at least partially bounded by water-soluble material, and the second compartment is the water-soluble material, in which components of the perhydrolase system are suspended.

FIG. 7B illustrates an embodiment of the unit-dose package that includes two compartments, wherein one compartment is at least partially bounded by water-soluble material, and the second compartment is a film applied to the water-soluble material.

FIG. 8 illustrates an embodiment of the unit-dose package in which the perhydrolase enzyme, acyl substrate, and peroxide source are provided in separate compartments.

FIG. 9 illustrates an embodiment of the unit-dose package in which the components of the perhydrolase system are provided in each of three separate compartments, at least one of which is formed of water-soluble material in which components of the perhydrolase system are suspended.

FIG. 10 illustrates an embodiment of the unit-dose package in which components of the perhydrolase system are provided in each of three separate compartments, wherein at least one of the compartments is the water-soluble material used to define a another compartment, and components of the perhydrolase system are suspended or dispersed in the water-soluble material.

FIG. 11 illustrates an embodiment of a the unit-dose package that includes four compartments, two being at least partially bounded by water-soluble material, and two being the water soluble material bounding the aforementioned compartments.

FIG. 12 illustrates an embodiment of the unit-dose package that includes a mesh or perforated enclosure.

FIGS. 13A-13C illustrate an embodiment of the unit-dose package having an enclosure that includes a casing with a mesh or perforated face having a plurality of openings. Side views of the unit-dose package are shown in FIGS. 13A and 13B and a front view is shown in FIG. 13C.

FIG. 14 illustrates an embodiment of the unit-dose package provided in a mesh or perforated enclosure and attached to an extended handle.

FIG. 15 illustrates an embodiment of the unit-dose package provided in a mesh or perforated enclosure and attached to string, rope, chain, or other elongated flexible structure.

FIG. 16 illustrates an embodiment of the unit-dose package that is enclosed in a housing similar to a conventional swimming pool chlorine dispenser.

### DETAILED DESCRIPTION

### Overview

Described are unit-dose packages designed to provide a perhydrolase enzyme system for use in cleaning applications, such as laundry and dishwashing. The described unit-dose packages utilize water-soluble materials to at least partially define one or more compartments capable of storing a perhydrolase enzyme, an acyl substrate, and source of peroxygen, and preventing these components from reacting until the package is contacted with water. These and other features and advantages of the present compositions and methods are described in detail.

### Definitions

Prior to describing the present compositions and methods in detail, the following terms are defined for clarity. Terms not defined should be given their ordinary meanings as using in the relevant art.

As used herein, a “unit-dose” or “single dose” package is a product format in which all components of an enzymatic bleaching system (i.e., a perhydrolase enzyme, an acyl substrate, and a peroxygen source) for use in a single batch process (e.g., washing a single load of laundry or dishes or performing a single cleaning operation) are provided in a convenient, single package format, which does not require the end-user/consumer to measure, apportion, or mix components from one or more larger containers. In addition to the components of the enzymatic bleaching system, the present unit-dose packages can further include detergent compositions, shine agents, fabric softeners, or other components that provide a benefit in the washing or cleaning application. Numerous unit-dose packages can be supplied in a single container (e.g., a box of unit-dose packages) without defeating the purpose of the unit-dose format.

As used herein, a “perhydrolase” is an enzyme capable of catalyzing a perhydrolysis reaction that results in the production of a peracid from a carboxylic acid ester (acyl) substrate in the presence of a source of peroxygen (e.g., hydrogen peroxide). While many enzymes perform this reaction at low levels, perhydrolases exhibit a high perhydrolysis:hydrolysis ratio, often greater than 1.

As used herein, the terms “perhydrolyzation,” “perhydrolyze,” or “perhydrolysis” refer to a reaction wherein a peracid is generated from a carboxylic acid ester (acyl) substrate and hydrogen peroxide.

As used herein, an “effective amount of perhydrolase enzyme” refers to the quantity of perhydrolase enzyme necessary to produce a desired effect in a cleaning, bleaching, or disinfection application, including but not limited to laundry and dishwashing.

As used herein, the term “peracid” refers to a molecule derived from a carboxylic acid ester (acyl) substrate that has been reacted with hydrogen peroxide to form a highly reactive product having the general formula RC(═O)OOH. Such peracid products are able to transfer one of their oxygen atoms to another molecule, such as a soil or stain on a surface. It is this ability to transfer oxygen atoms that enables a peracid, for example, peracetic acid, to function as a cleaning, bleaching, and disinfecting agent.

As used herein, a “carboxylic acid ester substrate” or an “acyl substrate” refers to a perhydrolase substrate that contains a carboxylic acid ester linkage. Esters comprising aliphatic and/or aromatic carboxylic acids and alcohols may be utilized as substrates with perhydrolase enzymes.

As used herein, the terms “hydrogen peroxide source,” “peroxide source,” or peroxygen source” refers to a molecule capable of generating hydrogen peroxide. Hydrogen peroxide sources include hydrogen peroxide, itself, as well as molecules that spontaneously, enzymatically, or chemically catalytically produce hydrogen peroxide as a reaction product. Such molecules include, e.g., perborate and percarbonate.

As used herein, the phrase “perhydrolysis to hydrolysis ratio” and “perhydrolysis:hydrolysis” refer to the ratio of enzymatically produced peracid to enzymatically produced acid (e.g., in moles) that is produced by a perhydrolase enzyme from an acyl substrate under defined conditions and within a defined time. The assays described in WO 05/056782A, WO 08/063,400A, US2008145353, and US2007167344 can be used to determine the amounts of peracid and acid produced by the enzyme.

As used herein, the term “acyl” refers to an organic group with the general formula RCO—, derived from an organic acid by removal of the —OH group. Typically, acyl group names end with the suffix “-oyl,” e.g., methanoyl chloride, CH₃CO—Cl, is the acyl chloride formed from methanoic acid, CH₃CO—OH).

As used herein, the term “acylation” refers to a chemical transformation in which one of the substituents of a molecule is substituted by an acyl group, or the process of introduction of an acyl group into a molecule.

As used herein, the term “transferase” refers to an enzyme that catalyzes the transfer of a functional group from one substrate to another substrate. For example, an acyl transferase may transfer an acyl group from an acyl substrate to a hydrogen peroxide substrate to form a peracid.

As used herein, the term “hydrogen peroxide generating oxidase” refers to an enzyme that catalyzes an oxidation/reduction reaction involving molecular oxygen (O₂) as the electron acceptor. In such a reaction, oxygen is reduced to water (H₂O) or hydrogen peroxide (H₂O₂). An oxidase suitable for use herein is an oxidase that generates hydrogen peroxide (as opposed to water) on its substrate. An example of a hydrogen peroxide generating oxidase and its substrate suitable for use herein is glucose oxidase and glucose. Other oxidase enzymes that may be used for generation of hydrogen peroxide include alcohol oxidase, ethylene glycol oxidase, glycerol oxidase, amino acid oxidase, etc. In some embodiments, the hydrogen peroxide generating oxidase is a carbohydrate oxidase.

As used herein, the term “textile” refers to fibers, yarns, fabrics, garments, and non-wovens. The term encompasses textiles made from natural, synthetic (e.g., manufactured), and various natural and synthetic blends. Textiles may be unprocessed or processed fibers, yarns, woven or knit fabrics, non-wovens, and garments and may be made using a variety of materials, some of which are mentioned, herein.

As used herein, a “cellulosic” fiber, yarn or fabric is made at least in part from cellulose. Examples include cotton and non-cotton cellulosic fibers, yarns or fabrics. Cellulosic fibers may optionally include non-cellulosic fibers.

As used herein, the term “fabric” refers to a manufactured assembly of fibers and/or yarns that has substantial surface area in relation to its thickness and sufficient cohesion to give the assembly useful mechanical strength.

As used herein, a “water soluble” or “water dispersible” material is a material that substantially dissolves within several minutes after contact with water. In particular, a material is considered water soluble or dispersible if 1 g of the material is 90% or more dissolved or dispersed in 1 L of 25° C. water in 5 min or less, e.g., 4 min or less, 3 min or less, 2 min or less, 1 min or less, 30 sec or less, or even 15 sec or less. [where did this definition come from?]

As used herein, an “aqueous medium” or “aqueous solution” is a solution and/or suspension in which the solvent is primarily water (i.e., the solvent is at least 50% water, at least 60% water, at least 70% water, at least 80% water, or even at least 90% water). The aqueous medium may include any number of dissolved or suspended components, including but not limited to surfactants, salts, buffers, stabilizers, complexing agents, chelating agents, builders, metal ions, additional enzymes and substrates, and the like. Exemplary aqueous media are laundry and dishwashing wash liquors. Materials such as textiles, fabrics, dishes, kitchenware, and other materials may also be present in or in contact with the aqueous medium.

As used herein, the term “low-water,” with reference to a liquid laundry detergent composition, indicates that the detergent composition contains about 70% or less water, for example, from about 10% to about 50% water (vol/vol). Examples of low water detergent compositions are concentrated heavy duty liquid (HDL) laundry detergents, such as ALL® Small & Mighty Triple Concentrated Liquid Laundry Detergent (Sun Products Corp.), ARM & HAMMER® 2× Concentrated Liquid Laundry Detergent (Church & Dwight), PUREX® concentrate Liquid Laundry Detergent (Henkel), TIDE® 2× Ultra Concentrated Liquid Laundry Detergent (Procter & Gamble), and the like.

As used herein, the term “very low-water,” with reference to a liquid laundry detergent composition, indicates that the detergent composition contains about 10% or less water, for example, from about 2% to about 10% water (vol/vol). Examples of very low-water detergent compositions are found in PUREX® UltraPacks (Henkel), FINISH® Quantum (Reckitt Benckiser), CLOROX™ 2 Packs (Clorox), OxiClean Max Force Power Paks (Church & Dwight), and TIDE® Stain Release, CASCADE® ActionPacs, and TIDE® Pods™ (Procter & Gamble). Preferred very low-water detergent compositions do not dissolve the water-soluble material used in the unit dose packages described, herein.

As used herein, a “non-aqueous medium” (e.g., a non-aqueous detergent composition) is a solution and/or suspension which includes a solvent that that is substantially free of water (i.e., the solvent is less than 10% water, less than 5% water, less than 3% water, less than 2% water, or even less than 1% water). In this context, the term “substantially free of water” means that the amount of water present in the subject liquid is insufficient to substantially dissolve water-soluble packaging. Substantially free of water typically means about 2% water or less (vol/vol).

As used herein, where a component is “provided in” a specified form (e.g., non-aqueous, very low water, solid, and the like), this form refers to the final form as the component exists in the unit-dose package, not the form in which it may be added to another component that is then added to the unit-dose package.

As used herein, the phrase “insufficient to substantially dissolve water-soluble packaging” means that a subject liquid does not dissolve more than 5% of a water-soluble material over a period of six months at room temperature (i.e., 25° C.).

As used herein, the term “bounded” with reference to the contents of water-soluble packaging means the specified contents, whether liquid, solid, or a combination, thereof, are physically contained in a compartment, at least a portion of which is defined by water-soluble material. In some cases, the contents are fully bounded by water-soluble material, meaning that the entire compartment is defined by the water-soluble material, as in the case of a pouch made of water-soluble material. In some cases, the contents are only partially bounded by water-soluble material, meaning that only a portion of the compartment is defined by the water soluble material, and the remainder is defined by water-insoluble material, as in the case of a cup or dish covered by a lid made of water-soluble material.

As used herein, the terms “suspended” and “dispersed” refer to the distribution of one component in another, for example, the distribution of a solid form of acyl substrate in water-soluble material.

As used herein, a “non-mixing” component is a component that does not dissolve an aforementioned solid form of one or more components of the perhydrolase system when present in the same compartment. Examples of non-mixing components are solid or gel, paste, or wax laundry or dishwashing detergent formulations, which can be present in the same compartment as a solid form of the perhydrolase enzyme, ester substrate, and/or peroxide source. Non-mixing components can also be provided in different phases (i.e., organic and aqueous).

As used herein, “cold” water is water having a temperature between freezing and about 25° C.

As used herein, “warm” water is water having a temperature between about 26° C. and about 37° C.

As used herein, “hot” water is water having a temperature between about 37° C. and boiling.

As used herein, a “low” pH is a pH of less than about 7.

As used herein, a “high” pH is a pH of greater than about 7.

As used herein, the term “contacting,” means bringing into physical contact, such as by placing a unit-dose package in an aqueous solution.

As used herein, “packaging” refers to a container capable of providing a perhydrolase enzyme, substrate for the perhydrolase enzyme, and/or hydrogen peroxide source in an easy to handle and transport form.

As used herein, a “solid” form of a chemical component refers to a powder, crystals, granules, aggregates, paste or wax thereof.

As used herein, a “liquid” form of a chemical component refers to a liquid, gel, or slurry.

As used herein, the terms “purified” and “isolated” refer to the removal of contaminants from a sample and/or to a material (e.g., a protein, nucleic acid, cell, etc.) that is removed from at least one component with which it is naturally associated. For example, these terms may refer to a material which is substantially or essentially free from components which normally accompany it as found in its native state, such as, for example, an intact biological system.

As used herein, “polypeptide” refers to any composition comprising amino acids linked by peptide bonds and recognized as a protein by those of skill in the art. The conventional one-letter or three-letter code for amino acid residues is used herein. The terms “polypeptide” and “protein” are used interchangeably herein to refer to polymers of amino acids of any length. The polymer may be linear or branched, it may comprise modified amino acids, and it may be interrupted by non-amino acids. The terms also encompass an amino acid polymer that has been modified naturally or by intervention; for example, disulfide bond formation, glycosylation, lipidation, acetylation, phosphorylation, or any other manipulation or modification, such as conjugation with a labeling component. Also included within the definition are, for example, polypeptides containing one or more analogs of an amino acid (including, for example, unnatural amino acids, etc.), as well as other modifications known in the art.

As used herein, functionally and/or structurally similar proteins are considered to be “related proteins.” In some embodiments, these proteins are derived from a different genus and/or species, including differences between classes of organisms (e.g., a bacterial protein and a fungal protein). In additional embodiments, related proteins are provided from the same species. Indeed, it is not intended that the processes, methods and/or compositions described herein be limited to related proteins from any particular source(s). In addition, the term “related proteins” encompasses tertiary structural homologs and primary sequence homologs. In further embodiments, the term encompasses proteins that are immunologically cross-reactive.

As used herein, the term “derivative” refers to a protein which is derived from a protein by addition of one or more amino acids to either or both the C- and N-terminal end(s), substitution of one or more amino acids at one or a number of different sites in the amino acid sequence, and/or deletion of one or more amino acids at either or both ends of the protein or at one or more sites in the amino acid sequence, and/or insertion of one or more amino acids at one or more sites in the amino acid sequence. The preparation of a protein derivative is preferably achieved by modifying a DNA sequence which encodes for the native protein, transformation of that DNA sequence into a suitable host, and expression of the modified DNA sequence to form the derivative protein.

Related (and derivative) proteins comprise “variant proteins.” In some embodiments, variant proteins differ from a parent protein, e.g., a wild-type protein, and one another by a small number of amino acid residues. The number of differing amino acid residues may be one or more, for example, 1, 2, 3, 4, 5, 10, 15, 20, 30, 40, 50, or more amino acid residues. In some aspects, related proteins and particularly variant proteins comprise at least 35%, 40%, 45%, 50%, 55%, 60%, 65%, 70%, 75%, 80%, 85%, 90%, 91%, 92%, 93%, 94%, 95%, 96%, 97%, 98%, or even 99% or more amino acid sequence identity. Additionally, a related protein or a variant protein refers to a protein that differs from another related protein or a parent protein in the number of prominent regions. For example, in some embodiments, variant proteins have 1, 2, 3, 4, 5, or 10 corresponding prominent regions that differ from the parent protein. Prominent regions include structural features, conserved regions, epitopes, domains, motifs, and the like.

Methods are known in the art that are suitable for generating variants of the enzymes described herein, including but not limited to site-saturation mutagenesis, scanning mutagenesis, insertional mutagenesis, random mutagenesis, site-directed mutagenesis, and directed-evolution, as well as various other recombinatorial approaches. Note that where a particular mutation in a variant polypeptide is specified, further variants of that variant polypeptide retain the specified mutation and vary at other positions not specified.

As used herein, the term “analogous sequence” refers to a sequence within a protein that provides similar function, tertiary structure, and/or conserved residues as the protein of interest (i.e., typically the original protein of interest). For example, in epitope regions that contain an alpha-helix or a beta-sheet structure, the replacement amino acids in the analogous sequence preferably maintain the same specific structure. The term also refers to nucleotide sequences, as well as amino acid sequences. In some embodiments, analogous sequences are developed such that the replacement amino acids result in a variant enzyme showing a similar or improved function. In some embodiments, the tertiary structure and/or conserved residues of the amino acids in the protein of interest are located at or near the segment or fragment of interest. Thus, where the segment or fragment of interest contains, for example, an alpha-helix or a beta-sheet structure, the replacement amino acids preferably maintain that specific structure.

As used herein, the term “homologous protein” refers to a protein that has similar activity and/or structure to a reference protein. It is not intended that homologs necessarily be evolutionarily related. Thus, it is intended that the term encompass the same, similar, or corresponding enzyme(s) (i.e., in terms of structure and function) obtained from different organisms. In some embodiments, it is desirable to identify a homolog that has a quaternary, tertiary and/or primary structure similar to the reference protein. In some embodiments, homologous proteins induce similar immunological response(s) as a reference protein. In some embodiments, homologous proteins are engineered to produce enzymes with desired activity(ies). The degree of homology between sequences may be determined using Clustal W (Thompson J. D. et al. (1994) Nucleic Acids Res. 22:4673-4680) with default parameters, i.e.:
Gap opening penalty: 10.0
Gap extension penalty: 0.05
Protein weight matrix: BLOSUM series
DNA weight matrix: IUB
Delay divergent sequences %: 40
Gap separation distance: 8
DNA transitions weight: 0.50
List hydrophilic residues: GPSNDQEKR
Use negative matrix: OFF
Toggle Residue specific penalties: ON
Toggle hydrophilic penalties: ON
Toggle end gap separation penalty OFF

For example, PILEUP is a useful program to determine sequence homology levels. PILEUP creates a multiple sequence alignment from a group of related sequences using progressive, pair-wise alignments. It can also plot a tree showing the clustering relationships used to create the alignment. PILEUP uses a simplification of the progressive alignment method of Feng and Doolittle, (Feng and Doolittle (1987) J. Mol. Evol. 35:351-360). The method is similar to that described by Higgins and Sharp (Higgins and Sharp (1989) CABIOS 5:151-153). Useful PILEUP parameters including a default gap weight of 3.00, a default gap length weight of 0.10, and weighted end gaps. Another example of a useful algorithm is the BLAST algorithm, described by Altschul et al. (Altschul et al. (1990) J. Mol. Biol. 215:403-410; and Karlin et al. (1993) Proc. Natl. Acad. Sci. USA 90:5873-5787). One particularly useful BLAST program is the WU-BLAST-2 program (See, Altschul et al. (1996) Meth. Enzymol. 266:460-480). Parameters “W,” “T,” and “X” determine the sensitivity and speed of the alignment. The BLAST program uses as defaults a word-length (W) of 11, the BLOSUM62 scoring matrix (See, Henikoff and Henikoff (1989) Proc. Natl. Acad. Sci. USA 89:10915) alignments (B) of 50, expectation (E) of 10, M′5, N′-4, and a comparison of both strands.

As used herein, the phrases “substantially similar” and “substantially identical,” in the context of at least two nucleic acids or polypeptides, typically means that a polynucleotide or polypeptide comprises a sequence that has at least about 70% identity, more preferably at least about 80% identity, yet more preferably at least about 90%, at least about 91%, at least about 92%, at least about 93%, at least about 94%, at least about 95%, at least about 96%, at least about 97%, at least about 98%, or even at least about 99% sequence identity, compared to the reference (i.e., wild-type) sequence using CLUSTAL W with default parameters.

As used herein, “wild-type” and “native” proteins are those found in nature. The terms “wild-type sequence,” and “wild-type gene” are used interchangeably herein, to refer to a sequence that is native or naturally occurring in a host cell. In some embodiments, the wild-type sequence refers to a sequence of interest that is the starting point of a protein engineering project. The genes encoding the naturally-occurring protein may be obtained in accord with the general methods known to those skilled in the art. The methods generally comprise synthesizing labeled probes having putative sequences encoding regions of the protein of interest, preparing genomic libraries from organisms expressing the protein, and screening the libraries for the gene of interest by hybridization to the probes. Positively hybridizing clones are then mapped and sequenced.

As used herein, the term “acid” with respect to a cellulase, an amylase, a protease, and the like, refers to the pH optima of the enzymes. Acid enzymes have pH optima of less than 7.

As used herein, the singular articles “a,” “an,” and “the” encompass the plural referents unless the context clearly dictates otherwise. All references sited herein are hereby incorporated by reference in their entirety.

The following abbreviations/acronyms have the following meanings unless otherwise specified:

cDNA complementary DNA

DNA deoxyribonucleic acid

EC enzyme commission

kDa kiloDalton

MW molecular weight

SDS-PAGE sodium dodecyl sulfate polyacrylamide gel electrophoresis

w/v weight/volume

w/w weight/weight

v/v volume/volume

wt % weight percent

° C. degrees Centigrade

H₂O water

H₂O₂ hydrogen peroxide

dH₂O or DI deionized water

dIH₂O deionized water, Milli-Q filtration

g or gm gram

μg microgram

mg milligram

kg kilogram

μL and μl microliter

mL and ml milliliter

mm millimeter

μm micrometer

M molar

mM millimolar

μM micromolar

U unit

ppm parts per million

sec and ″ second

min and ′ minute

hr hour

ETOH ethanol

eq. equivalent

N normal

CI Colour (Color) Index

CAS Chemical Abstracts Society

PGDA propylene glycol diacetate

### Unit-Dose Format Perhydrolase Systems

Described are unit-dose packages for providing a perhydrolase enzyme system for use in cleaning applications, such as laundry and dishwashing. The unit-dose packages utilize water-soluble materials to at least partially define one or more compartments capable of storing the components of the perhydrolase enzyme system (i.e., a perhydrolase enzyme, an acyl substrate, and source of peroxygen) and preventing these components from reacting until the package is contacted with water.

Various embodiments of the unit-dose packages are set forth, below, along with detailed descriptions of the components for use in the packages. The reader will appreciate that the document is organized for ease of reading, and that a description in one section of the document should be read in the context of the document as a whole. It will also be apparent that features discussed with reference to one embodiment can be combined with features discussed with reference to another embodiment. Where the same reference numbers are repeated in different Figures, they should be given the same meaning as in the first Figure in which they appeared.

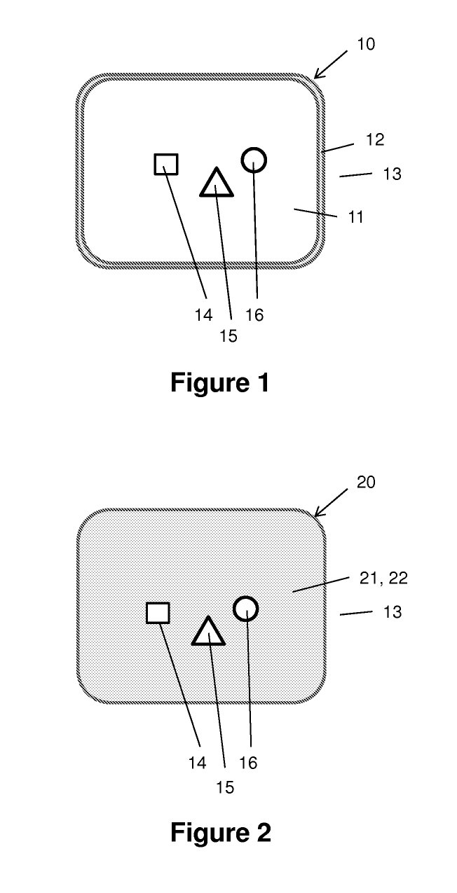

In the most simple embodiment, the unit-dose package 10 includes at least one compartment at 11 that is at least partially bounded by water-soluble material 12 to allow the release of the contents of the compartment, including components of the perhydrolase system 14, 15, 16, following contact with aqueous medium 13, e.g., water or wash liquor in a washing machine, dishwasher, or other container (FIG. 1). In an alternative embodiments, the unit-dose package 20 includes a compartment 21 that contains components of the perhydrolase system 14, 15, 16 suspended or dispersed in a water-soluble material 22 for dissolution and release of the components upon contact with water 13 (FIG. 2). In either case, the water soluble material is selected such that it substantially dissolves in 5 min or less, e.g., 4 min or less, 3 min or less, 2 min or less, 1 min or less, 30 sec or less, or even 15 sec or less upon contact with water, thereby releasing the contents of the compartment. In the absence of contact with water the water soluble material should remain intact for at least 6 months to prevent release of the contents of the compartment.

With respect to a perhydrolase system, the single compartment format requires that all three of the system components, i.e., the perhydrolase enzyme, the acyl substrate, and the peroxide source, are provided in the same compartment (generally represented by 14, 15, 16, respectively, in FIGS. 1 and 2). This can be accomplished by suspending solid perhydrolase (optionally in the form of granules) and a solid form of peroxide in liquid acyl substrate (see, e.g., US2009311395) or using solid perhydrolase (optionally in the form of granules), a solid form of peroxide, and a solid form of acyl substrate.

Particularly where the unit-dose package includes solid forms of the three system components, it may further comprise any number of additional non-mixing components, including, for example, any and all solid components normally found in solid laundry and/or dishwashing formulations or a gel, paste, or wax laundry and/or dishwashing formulation. Accordingly, the unit-dose package may contain all the components of a conventional solid and/or gel, paste, or wax detergent formulation plus a perhydrolase bleaching system.

In most embodiments, a compartment in a unit-dose package is entirely bounded by a water soluble material, which dissolves substantially completely in an aqueous wash liquor. However, it is contemplated that a compartment can be partially bounded by water soluble material and partially bounded by water insoluble material. Dissolution of the soluble material would allow the release of the contents of the compartment, while the insoluble material would remain in the wash liquor for later disposal or recycling.

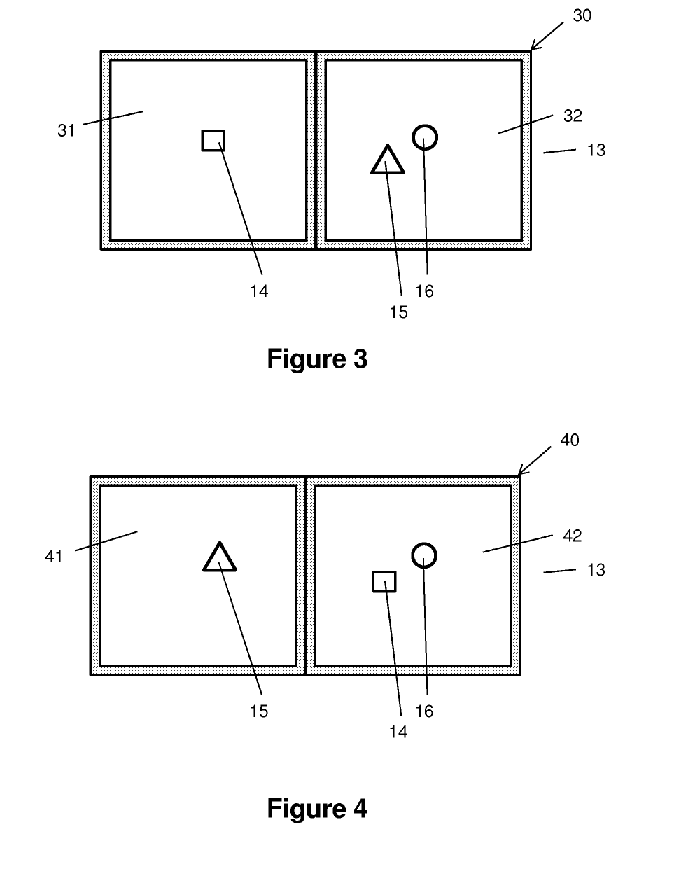

In some embodiments, the unit-dose package 30 includes two separate compartments 31, 32, allowing for segregation of components of the perhydrolase system 14, 15, and 16 (FIG. 3). In some embodiments of the two compartment unit-dose package, the perhydrolase enzyme 14 is provided in the first compartment 31 and the acyl substrate 15 and peroxide source 16 are provided in the second compartment 32. The perhydrolase enzyme can be provided in liquid or solid form, as described, herein. The acyl substrate and peroxide source can be provided in a low pH, non-aqueous solution, as described, herein. Alternatively, the acyl substrate can be a liquid and the peroxide source can be provided in solid form, or both the acyl substrate and the peroxide source can be provided in solid form.

Where the two compartment dose package includes a solid form of the perhydrolase enzyme, the chamber that contains the perhydrolase can further comprise any number of additional non-mixing components, including, for example, any and all solid components normally found in solid laundry and/or dishwashing formulations or a gel, paste, or wax laundry and/or dishwashing formulation. Where the two compartment dose package includes a liquid form of the perhydrolase enzyme the chamber that contains the perhydrolase can further comprise a very low-water liquid laundry and/or dishwashing formulation.

Where the two compartment dose package includes solid forms of the acyl substrate and the peroxide source the chamber that contains these components can further comprise any number of additional non-mixing components, including, for example, any and all solid components normally found in solid laundry and/or dishwashing formulations or a gel, paste, or wax laundry and/or dishwashing formulation.

In some embodiments of the two compartment unit-dose package 40, the acyl substrate 15 is provided in the first compartment 41 and the perhydrolase enzyme 14 and peroxide source 16 are provided in the second compartment 42 (FIG. 4). The acyl substrate can be a liquid, or can be provided in a non-aqueous solution. Alternatively, the acyl substrate can be a solid. The perhydrolase enzyme can be provided in the form of a liquid or a solid, and the peroxide source can be provided in solid form.

Where the two compartment dose package includes a solid form of the acyl substrate the chamber that contains the acyl substrate can further comprise any number of additional non-mixing components, including, for example, any and all solid components normally found in solid laundry and/or dishwashing formulations or a gel, paste, or wax laundry and/or dishwashing formulation.

Where the two compartment dose package includes solid forms of the perhydrolase enzyme and the peroxide source the chamber that contains these components can further comprise any number of additional non-mixing components, including, for example, any and all solid components normally found in solid laundry and/or dishwashing formulations or a gel, paste, or wax laundry and/or dishwashing formulation.

Where the two compartment dose package includes a liquid form of the acyl substrate in a first compartment and a solid or liquid form of the perhydrolase enzyme and solid or liquid form of peroxide source in a second compartment, the first or second compartment can further include a very low-water detergent composition.

In some embodiments of the two compartment unit-dose package 50, the peroxide source 16 is provided in the first compartment 51 and the acyl substrate and perhydrolase enzyme are provided in the second compartment 52. The peroxide source can be a liquid or a solid. The acyl substrate can be a liquid and the perhydrolase enzyme provided in solid form. Alternatively, the acyl substrate and the perhydrolase enzyme can be provided in a non-aqueous solution, or the acyl substrate can be a solid and the perhydrolase enzyme can be provided in liquid form.

Where the two compartment dose package includes a solid form of the peroxide source the chamber that contains the peroxide source may further comprise any number of additional non-mixing components, including, for example, any and all solid components normally found in solid laundry and/or dishwashing formulations or a gel, paste, or wax laundry and/or dishwashing formulation.

Where the two compartment dose package includes solid forms of the perhydrolase enzyme and the acyl substrate, the chamber that contains these components may further comprise any number of additional non-mixing components, including, for example, any and all solid components normally found in solid laundry and/or dishwashing formulations or a gel, paste, or wax laundry and/or dishwashing formulation. Where the two compartment dose package includes a solid form of the perhydrolase enzyme and a liquid form of the acyl substrate, the chamber that contains the perhydrolase and substrate may further comprise a very low-water liquid laundry and/or dishwashing formulation.

Where the two compartment dose package includes a solid or liquid form of the peroxide source in a first compartment and liquid forms of the perhydrolase enzyme and acyl substrate in a second compartment, the second compartment may further include a very low-water laundry and/or dishwashing formulation.

In some embodiments of the two compartment unit-dose package 60, one compartment 61 contains components of the perhydrolase system (not shown) suspended or dispersed in a water-soluble material 62 for dissolution and release of the components upon contact with water 13, while the other compartment 63 is at least partially bounded by water-soluble material (FIG. 6). In yet further embodiments, both compartments contain components of the perhydrolase system suspended or dispersed in a water-soluble material, rather than having one or more compartments at least partially bounded by water-soluble material (not shown).

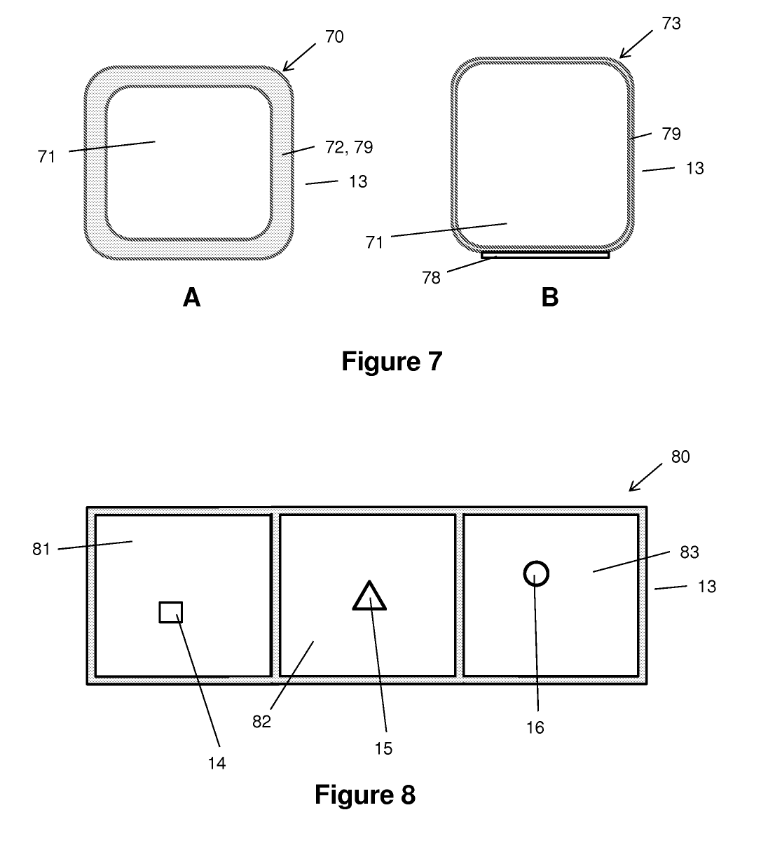

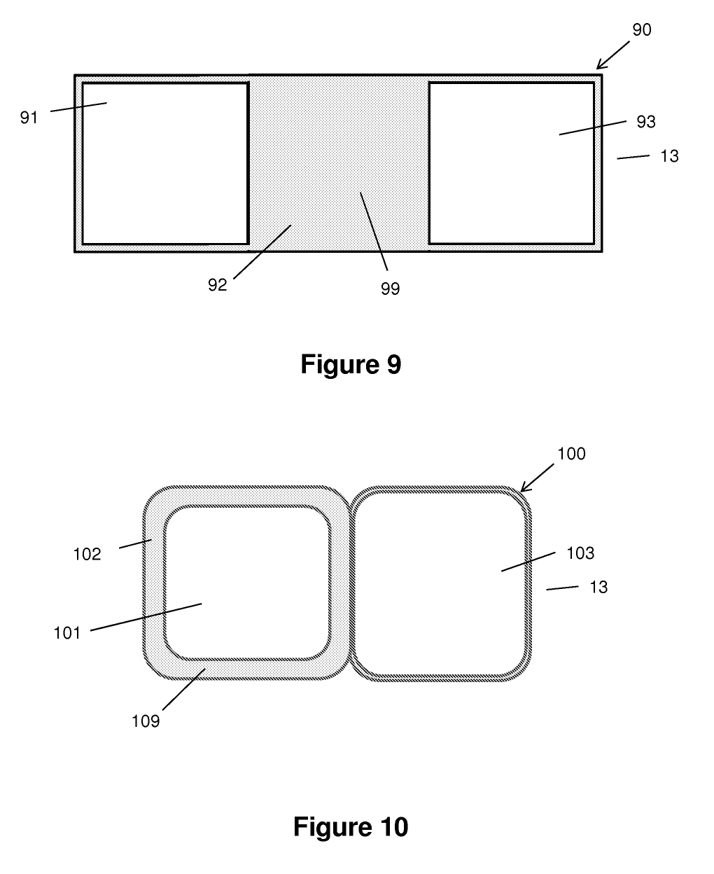

In a related embodiment of the two compartment unit-dose package 70, one compartment 71 can be at least partially bounded by water-soluble material 79, and the second compartment 72 can be the water-soluble material 79, in which one or more components of the perhydrolase system are suspended for dissolution and release of the components upon contact with water 13 (FIG. 7A). Solid forms of the perhydrolase enzyme and/or peroxygen source are readily suspended in the water-soluble material of the second compartment. This embodiment of the two compartment unit-dose package has the general appearance of a single-compartment package.

In another related embodiment of the two compartment unit-dose package 73, one compartment 71 can be at least partially bounded by water-soluble material 79, and the second compartment 78 can be a film applied to the water-soluble material 79 (FIG. 7B). The film can take the form or a coating, design, label, or logo, and may be applied by spraying, brushing, printing (including inkjet printing), and the like. The volume of the second compartment is generally small but is sufficient to contain a solid form of the perhydrolase enzyme. The reader will appreciate that such a film applied to the unit-dose package shown in previous FIG. 7A would effectively create a three compartment unit-dose package, although it would superficially have the appearance of a single compartment package.

In some embodiments of the unit-dose package 80, the perhydrolase enzyme 14, acyl substrate 15, and peroxide source 16 are provided in each of three separate compartments 81, 82, 83, respectively (FIG. 8). The arrangement of the three compartments is generally not critical. This arrangement allows maximum flexibility with respect to solid and liquid forms of any of the components. As with the forgoing arrangements, all solid components normally found in solid laundry and/or dishwashing formulations can be combined with a solid form of the perhydrolase enzyme, the acyl substrate, and/or the peroxide source.

In some embodiments of the unit-dose package 90 in which the components of the perhydrolase system (not shown) are provided in each of three separate compartments 91, 92, 93, at least one of the compartments 92 includes components of the perhydrolase system suspended or dissolved in water-soluble material 99, for dissolution and release of the components upon contact with water 13.

In some embodiments of the unit-dose package 100 in which the components of the perhydrolase system (not shown) are provided in each of three separate compartments 101, 102, 103, at least one of the compartments 102 can be the water-soluble material 109 used to define a second compartment 101, and components of the perhydrolase system can be suspended in the water-soluble material for dissolution and release of the components upon contact with water 13 (FIG. 10).

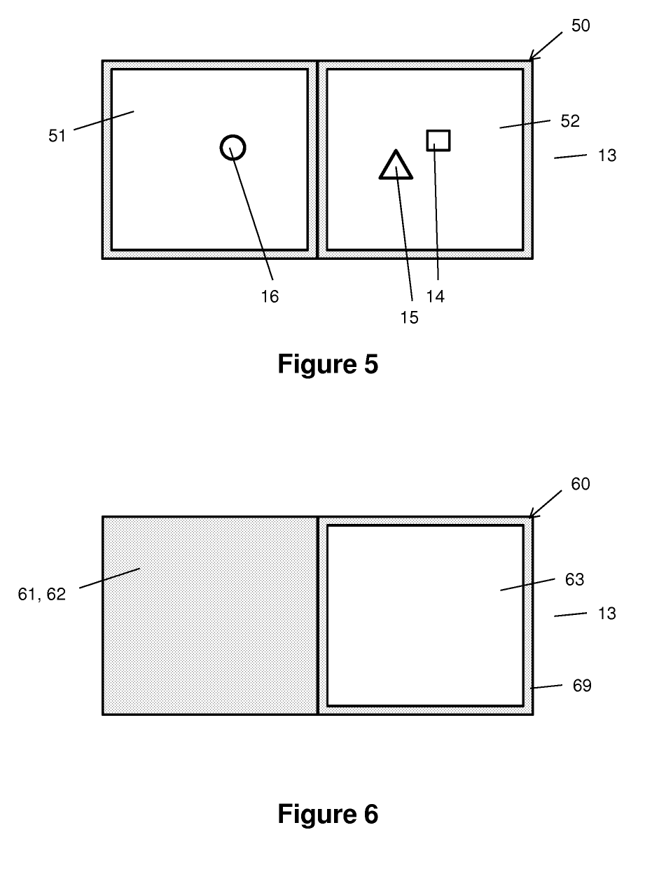

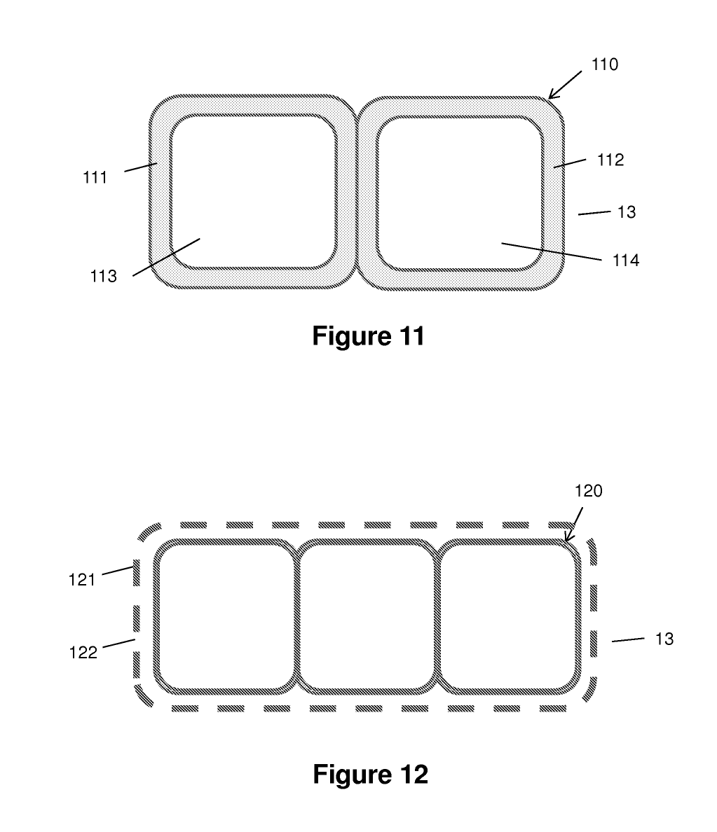

FIG. 11 shows yet a further embodiment of a the unit-dose package 110 that includes four compartments 111, 112, 113, 114, two being at least partially bounded by water-soluble material 113, 114 and two being the water soluble material bounding the aforementioned compartments 111, 112. This configuration is useful for additional functionality to the unit-dose container, for example, including a laundry or dishwashing component in a fourth compartment, isolated from the components of the perhydrolase system.

Where the two compartment or three compartment packages are used, the compartments are preferably adjacent and attached for ease of handling and use. This may be accomplished by forming a barrier in a single container package, e.g., by heat sealing. The compartments can share a common barrier, as illustrated in FIGS. 8 and 12, or can have their own barriers of water soluble material, as illustrated in FIGS. 3-6, 10, and 11. The compartments need not be the same size but should rather be optimized and minimized to suit the contents of each chamber. The water-soluble material used to make the package can be of uniform thickness, such that each component of the package is released at substantially the same time following contact with aqueous medium. Alternatively, the thickness of the water soluble material can vary, such that the contents of one compartment are released before the contents of another compartment. Different compartments can also be bounded by different water soluble materials, to affect different rates of release of the contents of the compartments, for example in response to temperature or pH.

Different compartments can have different sizes, shapes and arrangements to affect function or to impart a design on the unit-dose package. For example, a small round, triangular, heart-shaped, or otherwise styled compartment can be attached to a pillow-shaped compartment. Compartments can also be shaped like company trademarks. Different compartments can contain different dyes to further contribute to the overall design and appearance of the unit-dose package. Small compartments can be stacked on top of large compartments, or multiple compartments can be arranged in a rosette arrangement.

The foregoing embodiments contemplate that the materials used to make the unit-dose package will dissolve completely in the washing process, leaving no solid material to dispose of. However, in some embodiments of the unit-dose package, it may be desirable to provide an enclosure 121 for the water soluble packages 120, e.g., to provide protection during shipping and storage, to prevent individual unit-dose packages from sticking together in humid environments, to prevent the end user from sensing the tackiness/stickiness associated with some dissolving films, to prevent the transfer of fragrance (where present) to an end user's hands during handling, and the like (FIG. 12). The enclosure should be mesh or perforated such that it includes a sufficient number of openings 122 to permit water 13 to contact the soluble package to promote dissolution and the release of the components of the perhydrolase system. The mesh or perforated enclosure may be reusable, for example, the end user could open the enclosure to insert a fresh dissolving package, or the manufacturer could collect used enclosures for remanufacture. Alternatively or additionally, the enclosures can be made of a recyclable material. The mesh or perforated enclosure may also be coated, printed (including inkjet printing), painted, or otherwise include an active component, including a component of the perhydrolase system.

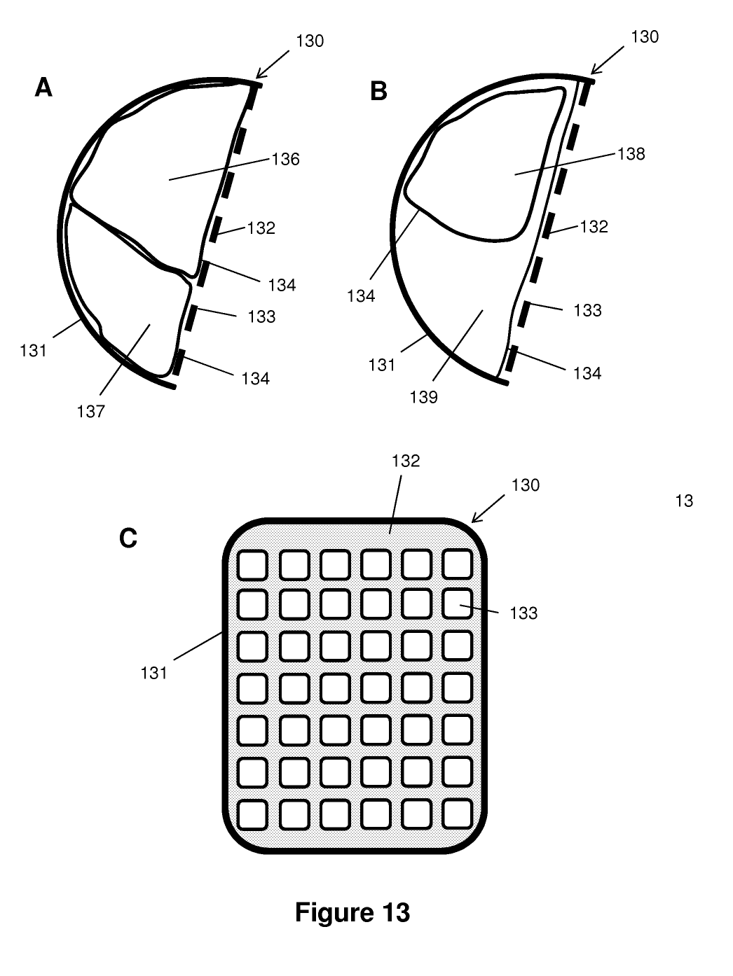

An exemplary enclosed unit-dose package is shown in FIG. 13A. The enclosure 130 includes a casing 131 with a mesh or perforated face 132 having a plurality of openings 133. The enclosure protects at least one single compartment 136, 137 (two are shown), which is/are at least partially bounded by water soluble material 134. Although two compartments are shown, the present embodiment can be used with one, two, three, or more compartments, as described, above. In some embodiments, a compartment 139 can be partially bounded by the casing 131, in which case water-soluble material 134 need only be present behind the perforated face 132 (FIG. 13B). An optional second compartment 138 is shown, which is completely bounded by water soluble material 134. Side views of the unit-dose package are shown in FIGS. 13A and 13B and a front view is shown in FIG. 13C.

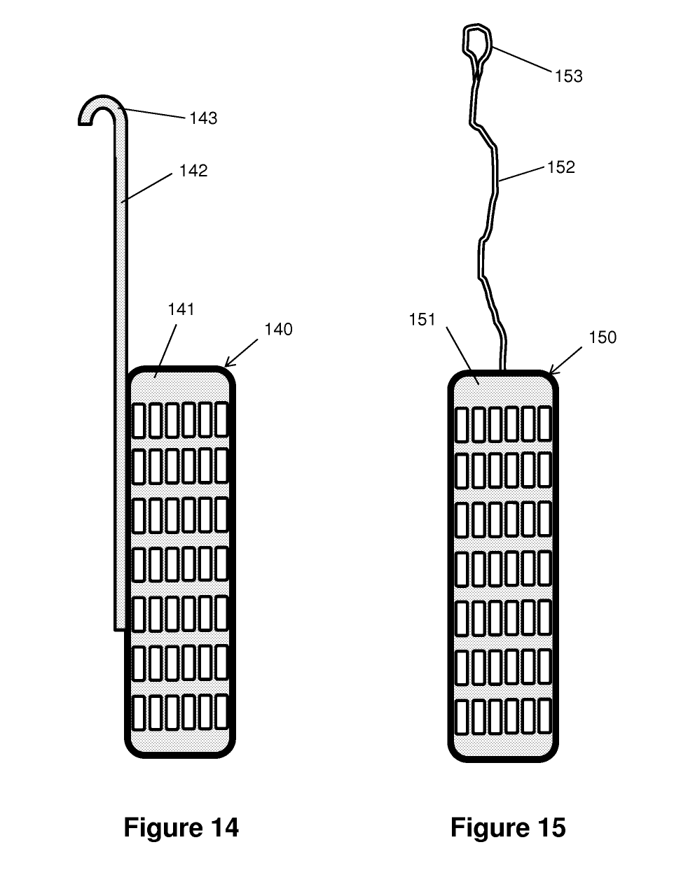

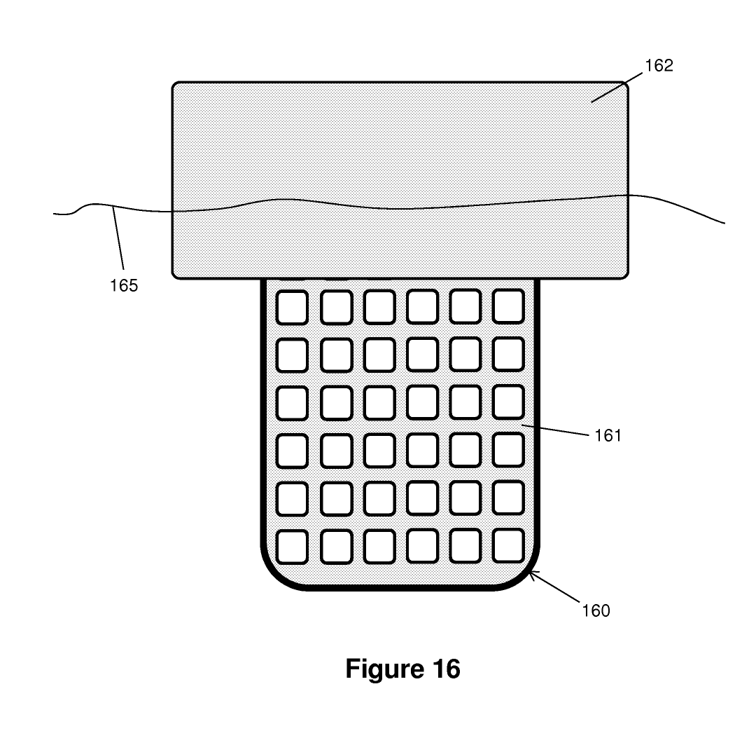

In some embodiments, the unit-dose package 140 is provided in a mesh or perforated enclosure 141, which is attached to an extended handle 142, which allows the unit-dose package to be stirred in a bucket or other vessel without requiring the end-user's hands (or other appendage) to contact the aqueous medium in which the unit-dose package is dissolved (FIG. 14). In some embodiments, the handle includes a hook 143, such that the unit-dose package can be suspended (i.e., hung over) the edge of a bucket, sink, toilet cistern or bowl, dishwasher basket, washing machine drum, or other vessel while the package is dissolving, while allowing the handle to be used, optionally for stirring. In related embodiments, the unit-dose package 150 is provided in a mesh or perforated enclosure 151, which is attached to string, rope, chain, or other elongated flexible structure 152, optionally with an attachment loop 153, which allows the unit-dose package to be tied or suspended above the bucket, sink, toilet cistern or bowl, dishwasher basket, washing machine drum, or other vessel while the package is dissolving (FIG. 15). In some embodiments, the perhydrolase system is used to clean, bleach, or disinfect the vessel itself (such as the washing machine or dishwasher), while in some embodiments the system is used to produce a peracid solution for use in bleaching, cleaning, or disinfecting other objects, e.g., driveways, decks, mold-covered surfaces, shower stalls, bathtubs, and the like.

In some embodiments, the unit-dose package 160 is provided in a mesh or perforated enclosure 161, which is attached to a floatation structure 162 as part of a larger assembly, which allows the unit-dose package to float on the surface of an aqueous liquid 165. Preferably, the unit-dose package can be reused by periodically adding a new unit dose package to the assembly. This embodiment is reminiscent of a swimming pool chlorine dispenser.

In the case of any of the foregoing unit-dose packaging formats, the packages may include any number of additional compartments for providing additional components, such as surfactants, salts, buffers, stabilizers, complexing agents, chelating agents, builders, metal ions, additional enzymes and substrates, fabric softeners, fragrance, polymers, and the like. Additional compartments can be attached to any of the aforementioned unit-dose packages, and such compartments can include solid, gel, paste, wax, or liquid forms of complete laundry or dishwashing detergent compositions, prewash compositions, fabric softeners, anti-spotting additives, fragrances, and the like. By varying the water-soluble material used to form these additional packages, or by varying the thickness of the films of these additional packages, it is possible to control the order in which different components contained within the unit-dose packaging are released, for example in response to temperature or pH.

In some embodiments, the unit-dose package includes a perhydrolase enzyme system contained within one, two, or three compartments, as described above, and at least one additional compartment containing a laundry or dishwashing detergent composition. The water soluble material used to contain the components of the perhydrolase enzyme system is thicker, or of a different material than the water soluble material used to contain the laundry or dishwashing detergent composition, such that the laundry or dishwashing detergent composition is released first into the wash liquor, allowing the surfactants and enzymes present in the laundry or dishwashing detergent composition to begin cleaning laundry or dishes before the perhydrolase enzyme system components are released and begin to produce peracid. This arrangement delays the production of peracid in the wash liquor, which peracid may react unfavorably with components of the laundry or dishwashing detergent composition.

In some embodiments, the unit-dose package includes a perhydrolase enzyme system contained within one, two, or three compartments, as described above, at least one additional compartment containing a laundry or dishwashing detergent composition, and at least one additional compartment that contains a cleaning component that works better at low pH, i.e., after the perhydrolase enzyme system has made peracid in the wash liquor. Exemplary cleaning components are acid cellulases, acid amylases, acid proteases, acid pectate lyases, and the like. The water soluble material used to contain the components of the perhydrolase enzyme system and laundry or dishwashing detergent composition is thinner, or of a different material than the water soluble material used to contain the cleaning component with improved performance at low pH, such that the laundry or dishwashing detergent composition and perhydrolase enzyme system components are released, first, allowing the perhydrolase enzyme system to lower the pH of the wash liquor before the cleaning component that has improved performance at low pH is released. In some embodiments, the detergent composition includes components, such as enzymes, that are selected to work at the lower pH of the wash liquor resulting from the production of peracids and/or the corresponding carboxylic acid formed by hydrolysis of the peracids (e.g., acetic acid).

In some embodiments, the unit-dose package includes a perhydrolase enzyme system contained within one, two, or three compartments, as described above, and at least one additional compartment containing a laundry or dishwashing detergent composition, and at least one additional compartment comprising at least one catalase. The water soluble material used to contain the components of the perhydrolase enzyme system and laundry or dishwashing detergent composition is thinner, or of a different material than the water soluble material used to contain the catalase, such that the laundry or dishwashing detergent composition and perhydrolase enzyme system components are released, first, allowing peracid formation and cleaning to take place before catalase is released near the end of the cleaning cycle to destroy residual hydrogen peroxide.

Particularly where the unit-dose package is provided in a mesh or perforated housing, an indicator system that is sensitive to the concentration of peracid may be included on or in the housing to allow the end user to monitor the generation of peracid, for example, to determine when the wash liquor is ready to use for a cleaning application. This embodiment is especially useful when the unit-dose package is dissolved in a bucket for cleaning, e.g., a driveway, deck, or other surface. In one example, the indicator system is conventional pH paper contained within the housing, which paper remains captive in the housing after the water soluble material has dissolved. In other embodiments, a colored pH sensitive indicator is included in a compartment in the unit-dose package, or in a separate water soluble package, for the purpose of indicating when a preselected amount of peracid has been generated.

### Perhydrolase Enzyme

The perhydrolase enzyme system, comprises a perhydrolase enzyme capable of generating peracids in the present of a suitable acyl substrate and hydrogen peroxide source.

In some embodiments, the perhydrolase enzyme is naturally-occurring enzyme. In some embodiments, the perhydrolase enzyme comprises, consists of, or consists essentially of an amino acid sequence that is at least about 70%, 75%, 80%, 85%, 90%, 91%, 92%, 93%, 94%, 95%, 96%, 97%, 98%, 99%, or even 99.5% identical to the amino acid sequence of a naturally-occurring perhydrolase enzyme. In some embodiments, the perhydrolase enzyme is from a microbial source, such as a bacterium or fungus.

In some embodiments, the perhydrolase enzyme is a naturally occurring Mycobacterium perhydrolase enzyme or a variant thereof. An exemplary enzyme is derived from Mycobacterium smegmatis. This enzyme, its enzymatic properties, its structure, and numerous variants and homologs, thereof, are described in detail in International Patent Application Publications WO 05/056782A and WO 08/063,400A, and U.S. Patent Publications US2008145353 and US2007167344, which are incorporated by reference.

The amino acid sequence of M. smegmatis perhydrolase is shown below (SEQ ID NO: 1):

MAKRILCFGDSLTWGWVPVEDGAPTERFAPDVRWTGVLAQQLGADFEVI
EEGLSARTTNIDDPTDPRLNGASYLPSCLATHLPLDLVIIMLGTNDTKA
YFRRTPLDIALGMSVLVTQVLTSAGGVGTTYPAPKVLVVSPPPLAPMPH
PWFQLIFEGGEQKTTELARVYSALASFMKVPFFDAGSVISTDGVDGIHF
TEANNRDLGVALAEQVRSLL

In some embodiments, a perhydrolase enzyme comprises, consists of, or consists essentially of the amino acid sequence set forth in SEQ ID NO: 1 or a variant or homologue thereof. In some embodiments, the perhydrolase enzyme comprises, consists of, or consists essentially of an amino acid sequence that is at least about 70%, 75%, 80%, 85%, 90%, 91%, 92%, 93%, 94%, 95%, 96%, 97%, 98%, 99%, or even 99.5% identical to the amino acid sequence set forth in SEQ ID NO: 1.

In some embodiments, the perhydrolase enzyme comprises one or more substitutions at one or more amino acid positions equivalent to position(s) in the M. smegmatis perhydrolase amino acid sequence set forth in SEQ ID NO: 1. In some embodiments, the perhydrolase enzyme comprises any one or any combination of substitutions of amino acids selected from M1, K3, R4, I5, L6, C7, D10, S11, L12, T13, W14, W16, G15, V17, P18, V19, D21, G22, A23, P24, T25, E26, R27, F28, A29, P30, D31, V32, R33, W34, T35, G36, L38, Q40, Q41, D45, L42, G43, A44, F46, E47, V48, I49, E50, E51, G52, L53, S54, A55, R56, T57, T58, N59, I60, D61, D62, P63, T64, D65, P66, R67, L68, N69, G70, A71, S72, Y73, S76, C77, L78, A79, T80, L82, P83, L84, D85, L86, V87, N94, D95, T96, K97, Y99F100, R101, R102, P104, L105, D106, I107, A108, L109, G110, M111, S112, V113, L114, V115, T116, Q117, V118, L119, T120, S121, A122, G124, V125, G126, T127, T128, Y129, P146, P148, W149, F150, I153, F154, I194, and F196.

In some embodiments, the perhydrolase enzyme comprises one or more of the following substitutions at one or more amino acid positions equivalent to position(s) in the M. smegmatis perhydrolase amino acid sequence set forth in SEQ ID NO: 1: L12C, Q, or G; T25S, G, or P; L53H, Q, G, or S; S54V, L A, P, T, or R; A55G or T; R67T, Q, N, G, E, L, or F; K97R; V125S, G, R, A, or P; F154Y; F196G.

In some embodiments, the perhydrolase enzyme comprises a combination of amino acid substitutions at amino acid positions equivalent to amino acid positions in the M. smegmatis perhydrolase amino acid sequence set forth in SEQ ID NO: 1: L12I S54V; L12M S54T; L12T S54V; L12Q T25S S54V; L53H S54V; S54P V125R; S54V V125G; S54V F196G; S54V K97R V125G; or A55G R67T K97R V125G.

In particular embodiments, the perhydrolase enzyme is the S54V variant of the M. smegmatis perhydrolase, which is shown, below (SEQ ID NO: 2); S54V substitution underlined):

MAKRILCFGDSLTWGWVPVEDGAPTERFAPDVRWTGVLAQQLGADFEVI
EEGLVARTTNIDDPTDPRLNGASYLPSCLATHLPLDLVIIMLGTNDTKA
YFRRTPLDIALGMSVLVTQVLTSAGGVGTTYPAPKVLVVSPPPLAPMPH
PWFQLIFEGGEQKTTELARVYSALASFMKVPFFDAGSVISTDGVDGIHF
TEANNRDLGVALAEQVRSLL

In some embodiments, the perhydrolase enzyme includes the S54V substitution but is otherwise at least about 70%, 75%, 80%, 85%, 90%, 91%, 92%, 93%, 94%, 95%, 96%, 97%, 98%, 99%, or even 99.5% identical to the amino acid sequence set forth in SEQ ID NOs: 1 or 2.

In some embodiments, the perhydrolase enzyme is a member of the carbohydrate family esterase family 7 (CE-7 family). The CE-7 family of enzymes has been demonstrated to be particularly effective for producing peroxycarboxylic acids from a variety of carboxylic acid ester (acyl) substrates when combined with a source of peroxygen (WO2007/070609 and U.S. Patent Application Publication Nos. 2008/0176299, 2008/176783, and 2009/0005590).

Members of the CE-7 family include cephalosporin C deacetylases (CAHs; E.C. 3.1.1.41) and acetyl xylan esterases (AXEs; E.C. 3.1.1.72). Members of the CE-7 esterase family share a conserved signature motif (Vincent et al., J. Mol. Biol., 330:593-606 (2003)).

In one aspect, the perhydrolase includes an enzyme comprising the CE-7 signature motif and at least 70%, 75%, 80%, 85%, 90%, 91%, 92%, 93%, 94%, 95%, 96%, 97%, 98%, 99%, or even 99.5% identical to the cephalosporin C deacetylase from Bacillus subtilis ATCC 31954.TM. (SEQ ID NO: 3), the cephalosporin C deacetylase from Bacillus subtilis subsp. subtilis str. 168 or Bacillus subtilis BE1010 (SEQ ID NO: 4), the cephalosporin acetyl hydrolase from Bacillus subtilis ATCC 6633 (SEQ ID NO: 5), the cephalosporin C deacetylase from Bacillus licheniformis ATCC 14580.TM. (SEQ ID NO: 6), the acetyl xylan esterase from Bacillus pumilus PS213 (SEQ ID NO: 7), the acetyl xylan esterase from Clostridium thermocellum ATCC 27405.TM. (SEQ ID NO: 8), the acetyl xylan esterase from Thermotoga neapolitana (SEQ ID NO: 9), the cephalosporin C deacetylase from Bacillus subtilis ATCC 29233.TM. (SEQ ID NO: 10), the acetyl xylan esterase from Thermotoga maritima or variants, thereof (SEQ ID NO: 11). These sequence are shown, below:

Cephalosporin C deacetylase from Bacillus subtilis
ATCC 31954.TM. (SEQ ID NO: 3):
MQLFDLPLDQLQTYKPEKTAPKDFSEFWKLSLEELAKVQAEPDLQPVDYPADGVKV
YRLTYKSFGNARITGWYAVPDKQGPHPAIVKYHGYNASYDGEIHEMVNWALHGYA
AFGMLVRGQQSSEDTSISLHGHALGWMTKGILDKDTYYYRGVYLDAVRALEVISSF
DEVDETRIGVTGGSQGGGLTIAAAALSDIPKAAVADYPYLSNFERAIDVALEQPYLEI
NSFFRRNGSPETEVQAMKTLSYFDIMNLADRVKVPVLMSIGLIDKVTPPSTVFAAYN
HLETEKELKVYRYFGHEYIPAFQTEKLAFFKQHLKG
Cephalosporin C deacetylase from Bacillus subtilis
subsp. subtilis str. 168 or Bacillus subtilis
BE1010 (SEQ ID NO: 4):
MQLFDLPLDQLQTYKPEKTAPKDFSEFWKLSLEELAKVQAEPDLQPVDYPADGVKV
YRLTYKSFGNARITGWYAVPDKEGPHPAIVKYHGYNASYDGEIHEMVNWALHGYA
TFGMLVRGQQSSEDTSISPHGHALGWMTKGILDKDTYYYRGVYLDAVRALEVISSF
DEVDETRIGVTGGSQGGGLTIAAAALSDIPKAAVADYPYLSNFERAIDVALEQPYLEI
NSFFRRNGSPETEVQAMKTLSYFDIMNLADRVKVPVLMSIGLIDKVTPPSTVFAAYN
HLETKKELKVYRYFGHEYIPAFQTEKLAFFKQHLKG
Cephalosporin acetyl hydrolase (CAH) from Bacillus subtilis
ATCC 6633 (SEQ ID NO: 5):
MQLFDLPLDQLQTYKPEKTTPNDFSEFWKSSLDELAKVKAAPDLQLVDYPADGVKV
YRLTYKSFGNARITGWYAVPDKEGPHPAIVKYHGYNASYDGEIHEMVNWALHGYA
AFGMLVRGQQSSEDTSISPHGHALGWMTKGILDKDTYYYRGVYLDAVRALEVISSF
DEVDETRIGVTGGSQGGGLTIAAAALSDIPKAAVADYPYLSNFERAIDVALEQPYLEI
NSFFRRNGSPETEEKAMKTLSYFDIMNLADRVKVPVLMSIGLIDKVTPPSTVFAAYN
HLETEKELKVYRYFGHEYIPAFQTEKLAFFKQHLKG
Cephalosporin C deacetylase from Bacillus licheniformis
ATCC 14580.TM. (SEQ ID NO: 6):
MQQPYDMPLEQLYQYKPERTAPADFKEFWKGSLEELANEKAGPQLEPHEYPADGV
KVYWLTYRSIGGARIKGWYAVPDRQGPHPAIVKYHGYNASYDGDIHDIVNWALHG
YAAFGMLVRGQNSSEDTEISHHGHVPGWMTKGILDPKTYYYRGVYLDAVRAVEVV
SGFAEVDEKRIGVIGASQGGGLAVAVSALSDIPKAAVSEYPYLSNFQRAIDTAIDQPY
LEINSFFRRNTSPDIEQAAMHTLSYFDVMNLAQLVKATVLMSIGLVDTITPPSTVFAA
YNHLETDKEIKVYRYFGHEYIPPFQTEKLAFLRKHLK
Acetyl xylan esterase from Bacillus pumilus PS213
(SEQ ID NO: 7):
MQLFDLSLEELKKYKPKKTARPDFSDFWKKSLEELRQVEAEPTLESYDYPVKGVKV
YRLTYQSFGHSKIEGFYAVPDQTGPHPALVRFHGYNASYDGGIHDIVNWALHGYAT
FGMLVRGQGGSEDTSVTPGGHALGWMTKGILSKDTYYYRGVYLDAVRALEVIQSFP
EVDEHRIGVIGGSQGGALAIAAAALSDIPKVVVADYPYLSNFERAVDVALEQPYLEIN
SYFRRNSDPKVEEKAFETLSYFDLINLAGWVKQPTLMAIGLIDKITPPSTVFAAYNHL
ETDKDLKVYRYFGHEFIPAFQTEKLSFLQKHLLLST
Acetyl xylan esterase from Clostridium thermocellum
ATCC 27405.TM. (SEQ ID NO: 8):
MAQLYDMPLEELKKYKPALTKQKDFDEFWEKSLKELAEIPLKYQLIPYDFPARRVK
VFRVEYLGFKGANIEGWLAVPEGEGLYPGLVQFHGYNWAMDGCVPDVVNWALNG
YAAFLMLVRGQQGRSVDNIVPGSGHALGWMSKGILSPEEYYYRGVYMDAVRAVEI
LASLPCVDESRIGVTGGSQGGGLALAVAALSGIPKVAAVHYPFLAHFERAIDVAPDG
PYLEINEYLRRNSGEEIERQVKKTLSYFDIMNLAPRIKCRTWICTGLVDEITPPSTVFA
VYNHLKCPKEISVFRYFGHEHMPGSVEIKLRILMDELNP
Acetyl xylan esterase from Thermotoga neapolitana
(SEQ ID NO: 9):
MAFFDMPLEELKKYRPERYEEKDFDEFWRETLKESEGFPLDPVFEKVDFHLKTVETY
DVTFSGYRGQRIKGWLLVPKLAEEKLPCVVQYIGYNGGRGFPHDWLFWPSMGYICF
VMDTRGQGSGWMKGDTPDYPEGPVDPQYPGFMTRGILDPGTYYYRRVFVDAVRAV
EAAISFPRVDSRKVVVAGGSQGGGIALAVSALSNRVKALLCDVPFLCHFRRAVQLVD
THPYVEITNFLKTHRDKEEIVFRTLSYFDGVNFAARAKVPALFSVGLMDTICPPSTVF
AAYNHYAGPKEIRIYPYNNHEGGGSFQAIEQVKFLKR
Cephalosporin C deacetylase from Bacillus subtilis
ATCC 29233.TM. (SEQ ID NO: 10):
MQLFDLPLDQLQTYKPEKTAPKDFSEFWKLSLEELAKVQAEPDLQPVDYPADGVKV
YRLTYKSFGNARITGWYAVPDKQGPHPAIVKYHGYNASYDGEIHEMVNWALHGYA
AFGMLVRGQQSSEDTSISPHGHALGWMTKGILDKDTYYYRGVYLDAVRALEVISSF
DEVDETRIGVTGGSQGGGLTIAAAALSDIPKAAVADYPYLSNFERAIDVALEQPYLEI
NSFFRRNGSPETEVQAMKTLSYFDIMNLADRVKVPVLMSIGLIDKVTPPSTVFAAYN
HLETEKELKVYRYFGHEYIPAFQTEKLAFFKQHLKG
Acetyl xylan esterase from Thermotoga maritima (SEQ ID NO: 11):
MAFFDLPLEELKKYRPERYEEKDFDEFWEETLAESEKFPLDPVFERMESHLKTVEAY
DVTFSGYRGQRIKGWLLVPKLEEEKLPCVVQYIGYNGGRGFPHDWLFWPSMGYICF
VMDTRGQGSGWLKGDTPDYPEGPVDPQYPGFMTRGILDPRTYYYRRVFTDAVRAV
EAAASFPQVDQERIVIAGGSQGGGIALAVSALSKKAKALLCDVPFLCHFRRAVQLVD
THPYAEITNFLKTHRDKEEIVFRTLSYFDGVNFAARAKIPALFSVGLMDNICPPSTVFA
AYNYYAGPKEIRIYPYNNHEGGGSFQAVEQVKFLKKLFEKG

Enzymes such as acetyl xylan esterase from Thermotoga maritima are described in U.S. Pat. No. 7,951,566. Exemplary variants of this enzyme include C277V, C277A, C277S, and C277T, which are described in U.S. Pat. No. 8,062,875.

In other embodiments, the perhydrolase enzyme is from Sinorhizobium meliloti, Mesorhizobium loti, Moraxella bovis, Agrobacterium tumefaciens, or Prosthecobacter dejongeii (WO2005056782), Pseudomonas mendocina (U.S. Pat. No. 5,389,536), or Pseudomonas putida (U.S. Pat. Nos. 5,030,240 and 5,108,457).

In some embodiments, the perhydrolase enzyme has a perhydrolysis:hydrolysis ratio of at least 1. In some embodiments, the perhydrolase enzyme has a perhydrolysis:hydrolysis ratio greater than 1. In some embodiments, the perhydrolysis:hydrolysis ratio is greater than 1.5, greater than 2.0, greater than 2.5, or even greater than 3.0.

In some embodiments, the perhydrolase enzyme is provided at a concentration of about 1 to about 100 ppm, or more. In some embodiments, the perhydrolase enzyme is provided at a molar ratio with respect to the amount of dye on the textile. In some embodiments, the molar ratio is from about 1/10,000 to about 1/10, or even from about 1/5,000 to about 1/100. In some embodiments, the concentration of perhydrolase enzyme is from about 10⁻⁹ M to about 10⁻⁵ M, from about 10⁻⁸ M to about 10⁻⁵ M, from about 10⁻⁸ M to about 10⁻⁶ M, about 5×10⁻⁸ M to about 5×10⁻⁷ M, or even about 10⁻⁷ M to about 5×10⁻⁷ M.

The perhydrolase enzyme may be provided as a liquid or a solid, depending on the packaging requirements. Liquid forms of the perhydrolase enzyme include stabilized, non-aqueous formulations that do not dissolve the soluble material in which the perhydrolase enzyme is contained. An exemplary formulation is described in U.S. Patent Pub. No. 20110300201. The formulation provides perhydrolase in a non-aqueous liquid phase (i.e., carrier fluid) in contact with barrier materials or suspended particles, films or monoliths comprising a polymeric matrix in which the enzyme is encapsulated. The polymer is insoluble in the carrier fluid but soluble in water. The liquid phase comprises less than 5%, less than 1%, or even less than 0.5% water. An advantage of this polymeric formulation is that an acyl substrate can be mixed with the encapsulated enzyme to produce a stable, non-reactive, co-formulated perhydrolase-substrate liquid mixture, which is suitable for use in many embodiments of the present unit-dose dissolving packages.

In some embodiments, the polymeric matrix comprises polyvinyl alcohol, methylcellulose, hydroxypropyl methylcellulose, polyvinyl pyrrolidone, guar gum, or a derivative or co-polymer thereof, or a mixture thereof. In some embodiments, the polymeric matrix contains one or more filler or extender (e.g., starch, sugar, clay, talc, calcium carbonate, titanium dioxide, cellulose fibers), plasticizer (e.g., glycerol, sorbitol, propylene glycol), cosolvent, binder, swelling agent (e.g., polyacrylate, croscarmellose sodium, sodium starch glycolate, low-substituted hydroxypropyl cellulose, galactomannan, Water-Lok, ZapLoc), or release agent.

In some embodiments, the polymers are negatively-charged polymers, such as hetero-polysaccharides including glucuronide and/or galacturonide residues. Such polysaccharides may for example include material produced by the organisms from which the enzymes themselves have been produced, and may remain as contaminants in the partially purified enzyme preparations even though they do not have, themselves have useful enzymatic activity. Alternatively or additionally, such polysaccharides may be added separately, in amounts up to about 1 to 5% by weight or more of the slurry. Such amounts may be comparable with those of the enzymes themselves. In some embodiments, the polysaccharides are present (or added) before spray-drying. Other exemplary polymers are arabinogalactans, xylogalalctans, and, generally, acid polysaccharides.

In some embodiments, the polymeric matrix comprises additional proteins or peptides, or derivatives, thereof. Some or all of the proteins or peptides may be present in a fermentation broth, cell media, or partially-purified protein preparations, and may remain as contaminants in the partially purified enzyme preparations even though they do not have, themselves have useful enzymatic activity. Alternatively or additionally, such polysaccharides may be added separately, in amounts up to about 1 to 5% by weight or more of the slurry. Such amounts may be comparable with those of the enzymes themselves.

In various embodiments, enzymes (and optionally substrates) are encapsulated in polymers using techniques including, but not limited to, solvent casting, spray drying, lyophilization/freeze-drying, fluid bed spray-coating, fluid-bed agglomeration, spray chilling, wet granulation, drum granulation, high-shear granulation, extrusion, spheronization, pan coating, coacervation, gelation, and atomization. In particular embodiments, spray-drying is used.

Generally, the amount of enzyme encapsulated in the polymeric matrix is less than 50% by weight. In various embodiments, the amount of enzyme encapsulated in the polymeric matrix is about 0.01% to about 50%, about 0.1% to about 25%, about 1% to about 10%, or about 2% to about 5% by weight.

In some embodiments, the enzyme-containing polymeric matrix is in the form of particles that are suspended in a liquid phase containing the substrate. In various embodiments, the particles are about 0.1 to about 1000, about 50 to about 250, about 100 to about 300, about 200 to about 500, about 400 to about 800, or about 600 to about 1000 micrometers in diameter.

In some embodiments, the polymeric matrix is in the form of a film which is about 5 to about 1000, about 50 to about 100, about 100 to about 200, or about 200 to about 500, or about 500 to about 1000 micrometers in thickness.

In some embodiments, the polymeric matrix is in the form of a monolith which is about 1 to 30 millimeters in thickness, in the longest dimension. The monolith can have any shape, from that of a thin flake to a more globular form, and it may be freely suspended or have a tendency to settle unless agitated or shaken.

Where the perhydrolase is present in a compartment in combination with a very low water or a non-aqueous detergent, stabilization in a polymeric matrix is unnecessary, and the enzyme can be added directly to the detergent.

In some embodiments, the perhydrolase enzyme is provided in solid form, such as a powder, precipitate, agglomerate, granule, microgranule, and the like. In some embodiments, an enzyme powder is formed by spray drying or lyophilizing the perhydrolase enzyme. The amount of enzyme present in the powder is preferably from about 5 weight percent (wt %) to about 75 wt % based on the dry weight of the enzyme powder. A preferred weight percent range of the enzyme in the enzyme powder is from about 10 wt % to 50 wt %, and a more preferred weight percent range of the enzyme in the enzyme powder is from about 20 wt % to 33 wt %.

In some embodiments, the enzyme powder further comprises an excipient, such as an inert filler, disintegrant, solubility enhancers, plasticizer, lubricant, surfactant, and the like. In one aspect, the excipient is provided in an amount in a range of from about 95 wt % to about 25 wt % based on the dry weight of the enzyme powder. A preferred wt % range of excipient in the enzyme powder is from about 90 wt % to 50 wt %, and a more preferred wt % range of excipient in the enzyme powder is from about 80 wt % to 67 wt %. Exemplary excipients are oligosaccharides and surfactants.

Specific oligosaccharides include, but are not limited to, maltodextrin, xylan, mannan, fucoidan, galactomannan, chitosan, raffinose, stachyose, pectin, insulin, levan, graminan, amylopectin, sucrose, lactulose, lactose, maltose, trehalose, cellobiose, nigerotriose, maltotriose, melezitose, maltotriulose, raffinose, kestose, and mixtures thereof. In a preferred embodiment, the oligosaccharide excipient is maltodextrin. Oligosaccharide-based excipients also include, but are not limited to, water-soluble non-ionic cellulose ethers, such as hydroxymethyl-cellulose and hydroxypropylmethylcellulose, and mixtures thereof. In yet a further embodiment, the excipient is selected from, but not limited to, one or more of the following compounds: trehalose, lactose, sucrose, mannitol, sorbitol, glucose, cellobiose, α-cyclodextrin, and carboxymethylcellulose.

Useful surfactants include, but are not limited to, ionic and nonionic surfactants or wetting agents, such as ethoxylated castor oil, polyglycolyzed glycerides, acetylated monoglycerides, sorbitan fatty acid esters, poloxamers, polyoxyethylene sorbitan fatty acid esters, polyoxyethylene derivatives, monoglycerides or ethoxylated derivatives thereof, diglycerides or polyoxyethylene derivatives thereof, sodium docusate, sodium laurylsulfate, cholic acid or derivatives thereof, lecithins, phospholipids, block copolymers of ethylene glycol and propylene glycol, and non-ionic organosilicones. Preferably, the surfactant is a polyoxyethylene sorbitan fatty acid ester, with polysorbate 80 being more preferred.

When part of the formulation used to prepare the enzyme powder, the surfactant is present in an amount in a range of from about 5 wt % to 0.1 wt % based on the weight of protein present in the enzyme powder, preferably from about 2 wt % to 0.5 wt % based on the weight of protein present in the enzyme powder. In a preferred embodiment, the enzyme powder/formulation is formed by spray drying.

The formulation used to prepare the enzyme powder may additionally comprise one or more buffers (e.g., sodium and/or potassium salts of bicarbonate, citrate, acetate, phosphate, pyrophosphate, methylphosphonate, succinate, malate, fumarate, tartrate, or maleate), and an enzyme stabilizer (e.g., ethylenediaminetetraacetic acid, (1hydroxyethylidene)bisphosphonic acid). The buffer may be present in an amount in a range of from about 0.01 wt % to about 50 wt % based on the weight of carboxylic acid ester in the formulation comprised of carboxylic acid ester and enzyme powder. The buffer may be present in a more preferred range of from about 0.10% to about 10% based on the weight of carboxylic acid ester in the formulation comprised of carboxylic acid ester and enzyme powder.

The enzyme powder or a formulation of the enzyme powder in a liquid acyl substrate substantially retains its enzymatic activity (e.g., retains at least 70%, at least 80%, at least 90%, or more of its activity) for an extended period of time when stored at ambient temperature (e.g., at least 6 months at 25° C. The enzyme powder may also be formulated with a solid acyl substrate and/or a solid peroxide source.

In some embodiments, the perhydrolase enzyme is provided in solid form in granules. Granules, including multi-layered granules, may be produced by a variety of fabrication techniques including: rotary atomization, wet granulation, dry granulation, spray drying, disc granulation, extrusion, pan coating, spheronization, drum granulation, fluid-bed agglomeration, high-shear granulation, fluid-bed spray coating, crystallization, precipitation, emulsion gelation, spinning disc atomization and other casting approaches, and prill processes. Such processes are known in the art and are described in U.S. Pat. Nos. 4,689,297, 5,324,649, 6248706, 6,534,466 and European Patents EP656058B1 and EP804532B 1.

Multi-layered granule can included an inner nucleus or “core.” U.S. Patent Publication No. 20100124586, U.S. Pat. No. 5,324,649, and International Patent No. WO9932595 describe suitable materials for the core. In some embodiments, the core comprises one or more water soluble or dispersible agent(s). Suitable water soluble agents include, but are not limited to, inorganic salts (e.g., sodium sulphate, sodium chloride, magnesium sulphate, zinc sulphate, and ammonium sulphate), citric acid, sugars (e.g., sucrose, lactose, glucose, granulated sucrose, maltodextrin and fructose), plasticizers (e.g., polyols, urea, dibutyl phthalate, and dimethyl phthalate), fibrous material (e.g., cellulose and cellulose derivatives such as hydroxyl-propyl-methyl cellulose, carboxy-methyl cellulose, and hydroxyl-ethyl cellulose), phytic acid, and combinations thereof. Suitable dispersible agents include, but are not limited to, clays, nonpareils (combinations of sugar and starch; e.g., starch-sucrose non-pareils—ASNP), talc, silicates, carboxymethyl cellulose, starch, and combinations thereof.

U.S. Patent Publication No. 20100124586, U.S. Pat. No. 5,324,649, and International Patent No. WO9932595 describe suitable materials for the coating layer. In some embodiments, the coating layer comprises one of more of the following materials: an inorganic salt (e.g., sodium sulphate, sodium chloride, magnesium sulphate, zinc sulphate, and ammonium sulphate), citric acid, a sugar (e.g., sucrose, lactose, glucose, and fructose), a plasticizer (e.g., polyols, urea, dibutyl phthalate, and dimethyl phthalate), fibrous material (e.g., cellulose and cellulose derivatives such as hydroxyl-propyl-methyl cellulose, carboxy-methyl cellulose, and hydroxyl-ethyl cellulose), clay, nonpareil (a combination of sugar and starch), silicate, carboxymethyl cellulose, phytic acid, starch (e.g., corn starch), fats, oils (e.g., rapeseed oil, and paraffin oil), lipids, vinyl polymers, vinyl copolymers, polyvinyl alcohol (PVA), plasticizers (e.g., polyols, urea, dibutyl phthalate, dimethyl phthalate, and water), anti-agglomeration agents (e.g., talc, clays, amorphous silica, and titanium dioxide), anti-foam agents (such as Foamblast 882® and Erol 6000K®, and talc. In one embodiment, the coating layer comprises sugars, such as sucrose. In one embodiment, the coating layer comprises a polymer such as polyvinyl alcohol (PVA). Suitable PVA for incorporation in the coating layer(s) of the multi-layered granule include partially hydrolyzed, fully hydrolyzed and intermediately hydrolyzed having low to high degrees of viscosity.

In some embodiments the core is coated with at least one coating layer. In one embodiment the core is coated with at least two coating layers. In another embodiment the core is coated with at least three coating layers. In a further embodiment the core is coated with at least four coating layers. In one embodiment, at least one coating layer is an enzyme coating layer. In some embodiments the core is coated with at least two enzyme layers. In another embodiment the core is coated with at least three enzyme layers.

In some embodiments, the granules of the present teachings comprise an enzyme coating layer. In some embodiments, the enzyme layer comprises at least one enzyme. In some embodiments the enzyme layer comprises at least two enzymes. In some embodiments, the enzyme layer comprises at least three enzymes. In addition to one or more perhydrolases, the coating(s) may further include, e.g., proteases, amylases, lipases, cellulases, hemi-cellulases, pectate lyases, phytases, xylanases, phosphatases, esterases, redox enzymes, transferases, beta-glucanases, oxidases (e.g. hexose oxidases and maltose oxidoreductases), and mixtures thereof.

In some embodiments, the enzyme coating layer may further comprise one or more additional materials selected from the group consisting of: sugars (e.g., sucrose), starch (e.g., corn starch), fats, oils (e.g. rapeseed oil, and paraffin oil), lipids, vinyl polymers, vinyl copolymers, polyvinyl alcohol (PVA), plasticizers (e.g., polyols, urea, dibutyl phthalate, dimethyl phthalate, and water), anti-agglomeration agents (e.g., talc, clays, amorphous silica, and titanium dioxide), anti-foam agents (such as Foamblast 882® and Erol 6000K® available from Ouvrie PMC, Lesquin, France), and talc. Foamblast 882® is available from Emerald Foam Control, LLC. Foamblast 882® is a defoamer which is made with food grade ingredients.

In some embodiments, the outer coating layer of a multi-layered granule comprises one or more of the following coating materials: polymers (e.g., vinyl polymers, polyvinyl alcohol, and vinyl copolymers), gums, waxes, fats, oils, lipids, lecithin, pigments, lubricants, nonpareils, inorganic salts (e.g. sodium sulphate, sodium chloride, magnesium sulphate, zinc sulphate, and ammonium sulphate), talc, and plasticizers (e.g. sugars, sugar alcohols, and polyethylene glycol). In a particular embodiment, the outer coating layer of a multi-layered granule comprises an inorganic salt (e.g., sodium sulphate), polyvinyl alcohol (PVA), talc or combinations thereof. In a particular embodiment, the outer coating layer comprises polyvinyl alcohol (PVA) and/or talc.

In some embodiments, a dry form of ester substrate and/or a dry form of peroxide source are included along with the perhydrolase enzyme in the same granule. Where reactive components of the perhydrolase system, or other reactive components, are included in the same granule, the different components can be separated by an intermediate layer to prevent reaction between the components. Such a layer may be referred to as a reaction barrier. The reaction barrier can be made of a water soluble polymeric material and/or materials. Preferred water soluble materials include, for example, polyvinyl acetate, methyl cellulose waxes and the like, sodium chloride, sucrose, magnesium sulfate, ammonium sulfate, hydroxypropyl methyl cellulose, ethyl cellulose, carboxy methyl cellulose, acacia gum, polyvinylpyrrolidone, mono and diglycerides, polyethylene glycol, non-ionic surfactants, starch, hydroxypropyl starch, hydroxyethyl starch and other modified starches.

The multi-layered granules described herein can be produced by a variety of techniques including: fluid-bed spray-coating, pan-coating, and other techniques for building up a multi-layered granule by adding consecutive layers on top of the starting core material (the seed). See, for example, U.S. Pat. No. 5,324,649 and U.S. Publication No. 20100124586. In some embodiments, the multi-layered granules are produced using a fluid-bed spray coating process.

In some embodiments, the multi-layered granules comprise or consist of a core comprising sodium sulphate; a first coating layer comprising or consisting of phytase, sucrose, starch, phytic acid and rapeseed oil; a second coating layer comprising or consisting of sodium sulphate; and a third coating layer comprising or consisting of talc and PVA. The first coating layer is applied to the core then the second coating layer is applied to the first coating layer and then the third coating layer is applied to second coating layer.

In another embodiment, the multi-layered granules comprise or consist of a core comprising sodium sulphate; a first coating layer comprising or consisting of phytase, sucrose, starch, phytic acid and an antifoam agent (such as Foamblast 882®); a second coating layer comprising or consisting of sodium sulphate; and a third coating layer comprising or consisting of talc and PVA. The first coating layer is applied to the core then the second coating layer is applied to the first coating layer and then the third coating layer is applied to second coating layer.

The perhydrolase is incorporated into the granules in such an amount that the purified enzyme is 0.001 to 50 weight percent in the granules. In some embodiments, the granules are formulated so as to contain an enzyme protecting agent and a dissolution retardant material (i.e., a material that regulates the dissolution of granules during use.

### Acyl Substrates

The perhydrolase enzyme system further comprises a carboxylic acid ester (acyl) substrate which is perhydrolyzed by the perhydrolase enzyme in the presence of hydrogen peroxide source to generate peracids.

In some embodiments, the acyl substrate is an ester of an aliphatic and/or aromatic carboxylic acid or alcohol. The acyl substrate may be a mono-, di-, tri-, or multivalent ester, or a mixture thereof. For example, the acyl substrate may be a carboxylic acid and a single alcohol (monovalent, e.g., ethyl acetate, propyl acetate), two carboxylic acids and a diol [e.g., propylene glycol diacetate (PGDA), ethylene glycol diacetate (EGDA), or a mixture, for example, 2-acetyloxy 1-propionate, where propylene glycol has an acetate ester on alcohol group 2 and a propyl ester on alcohol group 1], or three carboxylic acids and a triol (e.g., glycerol triacetate or a mixture of acetate/propionate, etc., attached to glycerol or another multivalent alcohol).

In some embodiments, the acyl substrate is an ester of a nitroalcohol (e.g., 2-nitro-1-propanol). In some embodiments, the acyl substrate is a polymeric ester, for example, a partially acylated (acetylated, propionylated, etc.) poly carboxy alcohol, acetylated starch, etc. In some embodiments, the acyl substrate is an ester of one or more of the following: formic acid, acetic acid, propionic acid, butyric acid, valeric acid, caproic acid, caprylic acid, nonanoic acid, decanoic acid, dodecanoic acid, myristic acid, palmitic acid, stearic acid, oleic acid, monoacetin, monopropionin, dipropionin, tripropionin, monobutyrin, dibutyrin, glucose pentaacetate, xylose tetraacetate, acetylated xylan, acetylated xylan fragments, β-D-ribofuranose-1,2,3,5-tetraacetate, tri-O-acetyl-D-galactal, tri-O-acetyl-glucal, propylene glycol diacetate, ethylene glycol diacetate, monoesters or diesters of 1,2-ethanediol, 1,2-propanediol, 1,3-propanediol, 1,2-butanediol, 1,3-butanediol, 2,3-butanediol, 1,4-butanediol, 1,2-pentanediol, 2,5-pentanediol, 1,6-pentanediol, 1,2-hexanediol, 2,5-hexanediol, or 1,6-hexanediol. In some embodiments, triacetin, tributyrin, and other esters serve as acyl donors for peracid formation. In some embodiments, the acyl substrate is propylene glycol diacetate, ethylene glycol diacetate, or ethyl acetate. In one embodiment, the acyl substrate is propylene glycol diacetate.

In some embodiments, the acyl substrate includes any one or more of the following:
(a) one or more esters having the structure

[X]ₘR₅
wherein
X is an ester group of the formula R₆C(O)O;
R₆ is a C1 to C7 linear, branched or cyclic hydrocarbyl moiety, optionally substituted with a hydroxyl group or C1 to C4 alkoxy group, wherein R₆ optionally comprises one or more ether linkages where R₆ is C2 to C7;
R₅ is a C1 to C6 linear, branched, or cyclic hydrocarbyl moiety optionally substituted with a hydroxyl group, wherein each carbon atom in R₅ individually comprises no more than one hydroxyl group or no more than one ester group, and wherein R₅ optionally comprises one or more ether linkages;
m is 1 to the number of carbon atoms in R₅,
said one or more esters having solubility in water of at least 5 ppm at 25° C.; or
(b) one or more glycerides having the structure

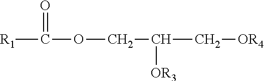

wherein R₁ is a C1 to C7 straight chain or branched chain alkyl optionally substituted with an hydroxyl or a C1 to C4 alkoxy group and R₃ and R₄ are individually H or R₁C(O); or
(c) one or more esters of the formula

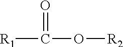

wherein R₁ is a C1 to C7 straight chain or branched chain alkyl optionally substituted with an hydroxyl or a C1 to C4 alkoxy group and R₂ is a C1 to C10 straight chain or branched chain alkyl, alkenyl, alkynyl, aryl, alkylaryl, alkylheteroaryl, heteroaryl, (CH₂CH₂O)ₙ, or (CH₂CH(CH₃)—O)ₙH and n is 1 to 10; or
(d) one or more acetylated monosaccharides, acetylated disaccharides, or acetylated polysaccharides; or
(e) any combination of (a) through (d).

As noted above, suitable substrates may be monovalent (i.e., comprising a single carboxylic acid ester moiety) or plurivalent (i.e., comprising more than one carboxylic acid ester moiety). The amount of substrate used for color modification may be adjusted depending on the number carboxylic acid ester moieties in the substrate molecule. In some embodiments, the concentration of carboxylic acid ester moieties in the final aqueous medium (e.g., wash liquor) is about 20-500 mM, for example, about 40 mM to about 400 mM, about 40 mM to about 200 mM, or even about 60 mM to about 200 mM. Exemplary concentrations of carboxylic acid ester moieties include about 60 mM, about 80 mM, about 100 mM, about 120 mM, about 140 mM, about 160 mM, about 180 mM, and about 200 mM.

In some embodiments, where the acyl substrate is divalent (as in the case of PGDA) it is provided in an amount of about 10-200 mM, for example, about 20 mM to about 200 mM, about 20 mM to about 100 mM, or even about 30 mM to about 100 mM. Exemplary amounts of ester substrate include about 30 mM, about 40 mM, about 50 mM, about 60 mM, about 70 mM, about 80 mM, about 90 mM, and about 100 mM. The skilled person can readily calculate the corresponding amounts of trivalent, or other plurivalent ester substrates based on the number of carboxylic acid esters moieties per molecule.

In some embodiments, the acyl substrate is a liquid, which includes viscous liquids and gels. Exemplary liquids are PGDA, triacetin, and other substrates listed herein, which are liquids at the temperature at which an end user is likely to use the present unit-dose packaged peracid generating system. Liquid substrates are preferably provided in non-aqueous form, or can be added to the same chamber as a very low water or non-aqueous detergent. In some embodiments, the acyl substrate is a solid, which includes gums resulting from hygroscopic solid acyl substrates. Exemplary liquids are 2,2-dimethyl-1,3-propanediol, paranitrophenyl acetate, glucose pentaacetate, and other substrates listed herein, which are solids at the temperature at which an end user is likely to use the present unit-dose packaged peracid generating system.

In some embodiments, the acyl substrate is provided in a molar excess with respect to the molar amount of dye on the textile to be subjected to color modification. In some embodiments, the carboxylic acid ester moieties of the ester substrate are provided at about 20 to about 20,000 times the molar amount of dye. Exemplary molar ratios of carboxylic acid ester moieties to dye molecules are from about 100/1 to about 10,000/1, from about 1,000/1 to about 10,000/1, or even 2,000/1 to about 6,000/1. In some cases, the molar ratio of acyl substrate to dye molecules is at least 2,000/1, or at least 6,000/1.

In some embodiments, where the acyl substrate is divalent (as in the case of PGDA) the acyl substrate is provided at about 10 to about 10,000 times the molar amount of dye. Exemplary molar ratios of acyl substrate to dye molecules are from about 50/1 to about 5,000/1, from about 500/1 to about 5,000/1, or even 1,000/1 to about 3,000/1. In some cases, the molar ratio of acyl substrate to dye molecules is at least 1,000/1, or at least 3,000/1. As before, the skilled person can readily calculate the corresponding amounts of trivalent, or other plurivalent acyl substrates based on the number of carboxylic acid esters moieties per molecule.

In some embodiments, the acyl substrate is provided at a concentration of about 100 ppm to about 100,000 ppm, or about 2500 to about 3500 ppm. In some embodiments, the acyl substrate is provided in a molar excess with respect to the perhydrolase enzyme. In some embodiments, the molar ratio of carboxylic acid ester moieties to perhydrolase enzyme is at least about 2×10⁵/1, at least about 4×10⁵/1, at least about 1×10⁶/1, at least about 2×10⁶/1, at least about 4×10⁶/1, or even at least about 1×10⁷/1, or more. In some embodiments, the acyl substrate is provided in a molar excess of from about 4×10⁵/1, to about 4×10⁶/1, with respect to the perhydrolase enzyme.

In some embodiments, where the acyl substrate is divalent (as in the case of PGDA), the molar ratio of acyl substrate to perhydrolase enzyme is at least about 1×10⁵/1, at least about 2×10⁵/1, at least about 5×10⁵/1, at least about 1×10⁶/1, at least about 2×10⁶/1, or even at least about 5×10⁶/1, or more. In some embodiments, the acyl substrate is provided in a molar excess of from about 2×10⁵/1 to about 2×10⁶/1, with respect to the perhydrolase enzyme. The skilled person can readily calculate the corresponding amounts of trivalent, or other plurivalent acyl substrates based on the number of carboxylic acid esters moieties per molecule.

In some embodiments, the acyl substrate is present in the mixed reaction formulation at a concentration of 0.05 wt % to 40 wt % of the reaction formulation, preferably at a concentration of 0.1 wt % to 20 wt % of the reaction formulation, and more preferably at a concentration of 0.5 wt % to 10 wt % of the reaction formulation.

### Peroxide Source

The perhydrolase enzyme system further includes at least one peroxide source. In some embodiments, the peroxide source is hydrogen peroxide. In some embodiments, the peroxide source is a compound that generates peroxide upon addition to water. The compound may be a solid or a liquid. Such compounds include adducts of hydrogen peroxide with various inorganic or organic compounds, of which the most widely employed is sodium carbonate per hydrate, also referred to as sodium percarbonate.

In some embodiments, the peroxide source is an inorganic perhydrate salt. Examples of inorganic perhydrate salts are perborate, percarbonate, perphosphate, persulfate and persilicate salts. Inorganic perhydrate salts are normally alkali metal salts. Additional hydrogen peroxide sources include adducts of hydrogen peroxide with zeolites, urea hydrogen peroxide, and carbamide peroxide.

The peroxide source may be in a crystalline form and/or substantially pure solid form without additional protection. For certain perhydrate salts, preferred forms are granular compositions involving a coating, which provides better storage stability for the perhydrate salt in the granular product. Suitable coatings comprise inorganic salts such as alkali metal silicate, carbonate or borate salts or mixtures thereof, or organic materials such as waxes, oils, or fatty soaps.

In some embodiments, the peroxide source is an enzymatic peroxide generation system. In one embodiment, the enzymatic hydrogen peroxide generation system comprises an oxidase and its substrate. Suitable oxidase enzymes include, but are not limited to: glucose oxidase, sorbitol oxidase, hexose oxidase, choline oxidase, alcohol oxidase, glycerol oxidase, cholesterol oxidase, pyranose oxidase, carboxyalcohol oxidase, L-amino acid oxidase, glycine oxidase, pyruvate oxidase, glutamate oxidase, sarcosine oxidase, lysine oxidase, lactate oxidase, vanillyl oxidase, glycolate oxidase, galactose oxidase, uricase, oxalate oxidase, and xanthine oxidase.

The following equation provides an example of a coupled system for enzymatic production of hydrogen peroxide:

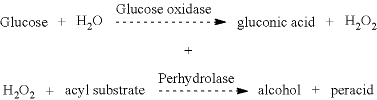

It is not intended that the generation of peroxide be limited to any specific enzyme, as any enzyme that generates peroxide with a suitable substrate may be used. For example, lactate oxidases from Lactobacillus species known to create peroxide from lactic acid and oxygen may be used. One advantage of such a reaction is the enzymatic generation of acid (e.g., gluconic acid in the above example), which reduces the pH of a basic aqueous solution to within the pH range in which peracid is most effective in bleaching (i.e., at or below the pKa). Such a reduction in pH is also brought about directly by the production of peracid. Other enzymes (e.g., alcohol oxidase, ethylene glycol oxidase, glycerol oxidase, amino acid oxidase, etc.) that are capable of generating hydrogen peroxide may also be used with acyl substrates in combination with a perhydrolase enzyme to generate peracids.

Where a coupled a coupled system for enzymatic production of hydrogen peroxide is used, the oxidase enzyme should be provided in a different compartment in the unit dose package than the substrate for the oxidase, or the oxidase and substrate should be provided in non-mixing forms such that they do not react until the unit dose package has been exposed to water. In some embodiments, the oxidase enzyme is in the same compartment as the perhydrolase enzyme, acyl substrate, or source of peroxygen. In some embodiments, the substrate for the oxidase enzyme is in the same compartment as the perhydrolase enzyme, acyl substrate, or source of peroxygen.

In some embodiments, the peroxide source is provided as a liquid at low pH, e.g., a pH less than about 6.5, less than about 6.0, less than about 5.5, less than about 5.0, less than about 4.5, or even less than about 4.0, to stability the hydrogen peroxide source against degradation.

In some embodiments, the peroxide source is provided at a concentration of about 100 ppm to about 10,000 ppm, about 1,000 ppm to about 3,000 ppm, or about 1,500 to about 2,500 ppm. In some embodiments, hydrogen peroxide is provided at about 10 to about 1,000 times the molar amount of dye.

In some embodiments, the peroxide source is provided in an amount of about 10-200 mM, for example, about 20 mM to about 200 mM, about 20 mM to about 100 mM, or even about 30 mM to about 100 mM. Exemplary amounts of hydrogen peroxide include about 30 mM, about 40 mM, about 50 mM, about 60 mM, about 70 mM, about 80 mM, about 90 mM, and about 100 mM.

In some embodiments, the peroxide source is provided in a molar excess with respect to the molar amount of dye to be subjected to color modification. In some embodiments, the hydrogen peroxide is provided at about 10 to about 10,000 times the molar amount of dye. Exemplary molar ratios of hydrogen peroxide to dye molecules are from about 500/1 to about 5,000/1, or even 1,000/1 to about 3,000/1. In some cases, the molar ratio of hydrogen peroxide to dye molecules is at least 1,000/1, or at least 3,000/1.

In some embodiments, the peroxide source is provided in a molar excess with respect to the perhydrolase enzyme. In some embodiments, the molar ratio of hydrogen peroxide to perhydrolase enzyme is at least about 1×10⁵/1, at least about 2×10⁵/1, at least about 5×10⁵/1, at least about 1×10⁶/1, at least about 2×10⁶/1, or even at least about 5×10⁶/1, or more. In some embodiments, the hydrogen peroxide is provided in a molar excess of about 2×10⁵/1 to 2×10⁶/1, with respect to the perhydrolase enzyme.

In some embodiments, the concentration of peroxygen compound in the reaction formulation may range from 0.0033 wt % to about 50 wt %, preferably from 0.033 wt % to about 40 wt %, more preferably from 0.33 wt % to about 30 wt %.

### Packaging Materials

The unit-dose package should be made from a water-soluble material, or should have at least one compartment which is bounded in part with a water-soluble material, which material is insoluble in non-aqueous medium or very low water-containing medium. It is desirable that the water-soluble material dissolve completely, even in cold water, to avoid leaving a residue on the objects to be treated with the contents of the package, and/or to avoid leaving a residue in a washing machine, dishwasher, or other vessel. The water-soluble material should begin to dissolve, such that the package begins to substantially release its contents within a few minutes of being contacted with water. Preferably, the contents of the package are substantially released in 5 min or less, 4 min or less, 3 min or less, 2 min or less, 1 min or less, or even 30 sec or less, after contact with water.

The dissolution rate and completeness of dissolution of the water-soluble material can be determined using a gravimetric method, in which a known amount of material is dissolved in water at a predetermined temperature and stirred vigorously (e.g., on a magnetic stirrer) for a predetermined amount of time. The mixture is then filtered through a sintered-glass filter with a pore size of no more than about 50 μm. The filtrate is collected and the water is removed by any conventional method (e.g., evaporation), and the weight of the polymer in the filtrate is determined, which equates to the dissolved or dispersed fraction. Then, the percentage solubility or dispersibility can then be calculated.

Preferred water-soluble materials are polymeric materials that can be formed into films. The films preferably have a thickness of 1-200 μm, more preferably 15-150 μm, even more preferably 30-100 μm. Films can be obtained using methods known in the art, including casting, blow-molding, extrusion, blow extrusion, and the like. The films may optionally be stretched during formation of the packaging or during filing and sealing of the packaging with the aforementioned contents. Stretching the films makes the final packaging more compact.

The polymer can have any weight average molecular weight, preferably from 1,000 to 1,000,000, from 10,000 to 300,000, from 15,000 to 200,000, or even from 20,000 to 150,000. Exemplary polymers and/or copolymers and/or derivatives, thereof, are selected from polyvinyl alcohol (PVA or PVOH), polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum; and mixtures thereof. More preferably the polymer is selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and mixtures thereof, most preferably polyvinyl alcohols, polyvinyl alcohol copolymers, hydroxypropyl methyl cellulose (HPMC), and mixtures thereof. Blends of polymers can be used to achieve the desired dissolution rate and storage stability, and different polymers can be used for different compartments of the packaging.

In some embodiments, the films comprise a PVOH polymer with similar properties to the film which comprises a PVOH polymer and is known under the trade reference M8630, as sold by Monosol LLC of Gary, Ind., U.S. Another preferred film is known under the trade reference PT-75, sold by Aicello Chemical Europe GmbH, Carl-Zeiss-Strasse 43, 47445 Moers, DE.

In some embodiments, the water soluble material is made from a combination of polyvinyl alcohol (PVOH), chitosan, and a crosslinking agent such as boric acid, as described in, e.g., WO2008063468. The resulting film preferably is formulated to be insoluble at a pH greater than about 9.3, and preferably greater than 10, and to be stable when in contact with detergent compositions. The resulting film also preferably has sufficient wet strength to withstand agitation in an automatic washing apparatus for the intended use during pre-rinse phases of washing.

The major components of the film used for the packet are PVOH, chitosan, and a crosslinking agent such as boric acid. Preferably, the PVOH is fully hydrolyzed (e.g., 99% to 100%), having a medium molecular weight, and having a 4% aqueous solution viscosity of about 20 cps to about 30 cps at 20° C. The PVOH is preferably present in a range of about 50% by weight, based on the total weight of the film (wt/wt) to about 90 wt/wt, on a dry basis, for example about 60 wt/wt to about 80 wt/wt, or about 70 wt/wt.

Chitin is a class of polymers of N-acetyl glucosamine with different crystal structures and degrees of deacetylation, and with fairly large variability from species to species. The polysaccharide obtained by more extensive deacetylation of chitin is chitosan. Both chitin and chitosan are insoluble in water, dilute aqueous bases, and most organic solvents. However, unlike chitin, chitosan is soluble in dilute aqueous acids, usually carboxylic acids, as the chitosonium salt. Chitosan is available in different molecular weights and is generally regarded as non-toxic and biodegradable. The degree of acetylation has a significant effect on the amine group pKa, and hence solubility behavior, and the rheological properties of the polymer. The amine group on the mostly deacetylated polymer has a pKa in the range of 5.5 to 6.5, depending on the source of the polymer. At low pH, the polymer is soluble, with the sol-gel transition occurring at approximate pH 7.

The degree of acetylation of the chitosan influences the pH value at which the film begins to dissolve. As the degree of acetylation increases, the pH above which the film dissolves increases. The degree of acetylation of the chitosan is preferably about 65% or less, or 70% or less, for example in ranges such as about 50% to about 65%, about 55% to about 65%, or about 60% to about 65%, to provide a film with a pH solubility trigger of about 9.2 or 9.3. This material can be obtained by a reacetylation reaction, using acetic anhydride, of commercially available 85% to 95% deacetylated chitosan in aqueous acetic acid, by methods known in the art. An average molecular weight of about 150,000 Da to about 190,000 Da is preferred. Chitosan is preferably present in a range of about 1 wt/wt to about 20 wt/wt. The weight ratio of PVOH to chitosan is about 12:1 to about 3:1, or about 8:1 to about 10:1, for example about 9:1.

It is believed that crosslinking agents, such as borax, borates, boric acid, citric acid, maleic acid, oxalic acid, malonic acid, succinic acid, cupric salts, water-soluble polyamide-epichlorohydrin, and combinations thereof, weakly crosslink PVOH to chitosan and enhance the wet strength of the resulting film. The crosslinking agent preferably is present in an amount up to about 10 wt/wt, for example about 0.1 wt/wt to about 10 wt/wt, or 0.1 wt/wt to about 5 wt/wt, depending on the type of crosslinking agent. Boric acid preferably is used in an amount in a range of about 0.3 wt/wt to about 0.7 wt/wt.

The film may further comprise other additives of ingredients besides the polymer or polymer material. For example, it may be beneficial to add plasticizers (for example glycerol, ethylene glycol, diethylene glycol, propylene glycol, sorbitol and mixtures thereof), additional water, disintegrating aids, lubricants, release agents, fillers, extenders, crosslinking agents, antiblocking agents, antioxidants, detackifying agents, antifoams, nanoparticles such as layered silicate-type nanoclays (e.g., sodium montmorillonite), bleaching agents (e.g., sodium bisulfite), and other functional ingredients, in amounts suitable for their intended purpose. The amount of such secondary agents is preferably up to about 10 wt/wt, more preferably up to about 5 wt/wt. In some embodiments, the film is itself a compartment of the unit-dose package, in which case it may comprise the perhydrolase enzyme, acyl substrate, and/or a solid peroxide source. The film may also comprise detergent composition components, for example, surfactants, organic polymeric soil release agents, dispersants, dyes, transfer inhibitors, fabric softener, sheeting agents, drying agents, and/or fragrances.

While the unit-dose package should have at least one compartment which is bounded in part with a water-soluble material, a portion of the unit-dose package may be made from insoluble material. For example, the unit-dose package may include a scaffold structure to which the water soluble material attaches, or an enclosure that surrounds the compartment(s) bounded by water-soluble material. The insoluble material is preferably a low cost, recyclable, polymeric material, such as polyethylene terephthalate, polyethylene, polyvinyl chloride, polypropylene, polycarbonate, and the like, although it could in theory be wood or metal. Particularly where the unit-dose container is intended for laundry use, the surface of the insoluble material should be smooth and free from sharp corners, which could damage clothing.

Exemplary water soluble films are described in international patent applications WO2008063468, WO2011094687, and WO2011094690, U.S. Pat. Nos. 8,008,241, 7,671,003, 7,615,524, 7,517,847, 7,507,699, 7,479,475, 7,472,710, 7,452,853, 7,282,472, 7,115,173, 7,086,110, 7,074,748, 7,036,177, 7,033,980, 7,022,659, 7,001,878, 6,998,375, 6,956,016, 6,812,199, 6,750,191, 6,740,628, 6,670,314, 6,632,785, 6,503,879, 6,475,977, 6,448,212, 6,303,553, 6,228,825, 4,925,586, D656,668 S, D657,495 S, D657,495 S, D651,340 S, D656,669 S, D656,670, D656,671 S, D657,910 S, D656,672 S, D656,673 S, D656,674 S, D640,934 S, D648,481 S, D639,182 S, D639,183 S, and D639,184 S, and U.S. Patent Pub. Nos. 20110201685, 20110017239, 20100120650, 20080004198, 20070203047, 20070123444, 20060019866, 20050256024, 20050215457, 20050139241, 20050124521, 20050065053, 20050039781, 20050020476, 20050003992, 20040255395, 20040235697, 20040216500, 20040147427, 20040142841, 20040142840, 20040053798, 20040018953, 20030224959, 20030213500, 20030172960, 20030114332, 20030092590, 20030050208, 20030003095, 20020187910, 20020187909, 20020142931, and 20020142930, all of which are incorporated by reference in their entirety.

Water-soluble packaging materials are commercially available from manufacturers such as MonoSol (Merrillville, Ind., USA) and Multi-Pack (Chatsworth, Calif., USA). Exemplary commercially available unit dose packages that can readily be adapted to deliver a perhydrolase enzyme system in accordance with the present description include PUREX® UltraPacks (Henkel), FINISH® Quantum (Reckitt Benckiser), CLOROX™ 2 Packs (Clorox), OxiClean Max Force Power Paks (Church & Dwight), and TIDE® Stain Release, CASCADE® ActionPacs, and TIDE® Pods™ (Procter & Gamble).

### UTILITY

The present unit-dose packages have numerous applications for cleaning, disinfecting, and bleaching. In some embodiments, the unit-dose packages are for laundry application, particularly machine wash laundry application in top-loading and front-loading washing machines. In such applications, the unit dose packages are added to the washing machine as it is filing with water or after it is filled with water. Where the unit dose package does not include a laundry detergent composition, it can be added separately. Ideally, clothes are added to the washing machine after the unit dose package has dissolved and all perhydrolase components and detergent components have dispersed in the wash liquor, although it is appreciated and contemplated that many consumers follow a less regimented protocol. A feature of the present unit dose packages is that a finite amount of time and an adequate amount of water is required to dissolve the package and form peracid in the wash liquor, therefore adding the unit dose package on top of clothes to be washed, or adding clothes to be washed and the unit dose package simultaneous to the washing machine is unlikely to cause unwanted bleaching.

In other embodiments, the unit-dose packages are for dishwashing applications, particularly in automatic washing machines. In such applications, the unit dose packages are added to the detergent dispenser of the dishwasher, or placed on a rack within the dishwasher prior to beginning a typical automatic wash cycle. Where the unit dose package does not include a dishwashing detergent composition, it can be added separately.

In yet other embodiments, the unit-dose packages are for cleaning applications that do not require specialized washing equipment. In such cases, the unit dose packages can be mixed with water or other aqueous medium in a bucket, sink, basin, part-cleaner, bath tub, toilet bowl, toilet bowl tank/cistern, or other vessel. Where the unit dose package does not include a detergent composition, it can be added separately. Exemplary items to be cleaned include, but are not limited to, clothes, dishes, driveways, decks, tires, animal facilities, hospital floors, medical equipment, and other surfaces. In some embodiments, the unit-dose packages are used to clean, bleach, or disinfect washing machines or dishwashers themselves.

In any of the aforementioned application, the unit dose package may advantageously be provided in a mesh or perforated container to assist in handling. In such cases, the housing can be recovered from the vessel after the unit dose package has dissolved or after the wash application is complete. In some embodiments, the housing is attached to a handle, rod, hook, string, rope, chain, or other structure to impart functionality.

These and other aspects and embodiments of the present compositions and method will be apparent to the skilled person in view of the present description. The following examples are intended to further illustrate, but not limit, the compositions and methods.

Although the foregoing invention has been described in some detail by way of illustration and examples for purposes of clarity of understanding, it will be apparent to those skilled in the art that certain changes and modifications may be practiced without departing from the spirit and scope of the invention. Therefore, the description should not be construed as limiting the scope of the invention.

All publications, patents, and patent applications cited herein are hereby incorporated by reference in their entireties for all purposes and to the same extent as if each individual publication, patent, or patent application were specifically and individually indicated to be so incorporated by reference.

What is claimed is:

1. A unit-dose package for delivering a perhydrolase enzyme system in a cleaning application, the perhydrolase enzyme system comprising a perhydrolase enzyme component, an acyl substrate component, and a peroxide source component, the package comprising:
a first compartment at least partially bounded by a water-soluble material and comprising a first component of the perhydrolase enzyme system;
a second compartment at least partially bounded by a water-soluble material and comprising a second component and a third component of the perhydrolase enzyme system;
wherein the first component in the first compartment and the second and third components in the second compartment are separated during storage to prevent the formation of peracids, and wherein upon dissolution in an aqueous solution the first compartment and second compartment dissolve simultaneously or sequentially to permit contact of the first, second, and third components of the perhydrolase enzyme system to generate peracid.

2. The unit-dose package of claim 1, wherein the first component is the perhydrolase enzyme, the second component is the acyl substrate, and the third component is the peroxide source.

3. The unit-dose package of claim 1, wherein the first component is the acyl substrate, the second component is the perhydrolase enzyme, and the third component is the peroxide source.

4. The unit-dose package of claim 1, wherein the first component is the peroxide source, the second component is the acyl substrate, and the third component is the perhydrolase enzyme.

5. The unit-dose package of claim 1, wherein a very low-water, non-aqueous, or non-mixing form of laundry or dishwashing detergent is additionally provided in the first compartment.

6. The unit-dose package of claim 5, wherein the first component is a perhydrolase enzyme provided in liquid or solid form, the second component is an acyl substrate provided in non-aqueous liquid form, and the third component is a peroxide source provided in solid form.

7. The unit-dose package of claim 5, wherein the first component is an acyl substrate provided in non-aqueous liquid form, the second component is a perhydrolase enzyme provided in solid or non-aqueous liquid form, and the third component is the peroxide source provided in solid form.

8. The unit-dose package of claim 5, wherein the first component is a peroxide source provided in solid form, the second component is an acyl substrate provided in non-aqueous liquid form, and the third component is a perhydrolase enzyme provided in solid or non-aqueous liquid form.

9. The unit-dose package of claim 5, wherein the laundry or dishwashing detergent is provided as a non-mixing form selected from the group consisting of a solid, a gel, a paste, or a wax.

10. The unit-dose package of claim 5, wherein the laundry or dishwashing detergent is provided as a very low-water liquid having a water content of less than about 10%.

11. The unit-dose package of claim 5, wherein the laundry or dishwashing detergent is non-aqueous.

12. The unit-dose package of claim 1, wherein a very low-water, non-aqueous, or non-mixing form of laundry or dishwashing detergent is additionally provided in the second compartment.

13. The unit-dose package of claim 12, wherein the first component is a perhydrolase enzyme provided in solid or liquid form, the second component is an acyl substrate provided in non-aqueous form, and the third component is a peroxide source provided in solid form.

14. The unit-dose package of claim 12, wherein the first component is acyl substrate provided in liquid form, the second component is a perhydrolase enzyme provided in solid or non-aqueous liquid form, and the third component is a peroxide source provided in solid form.

15. The unit-dose package of claim 12, wherein the first component is a peroxide source provided in solid or liquid form, the second component is an acyl substrate provided in non-aqueous liquid form, and the third component is a perhydrolase enzyme provided in solid or non-aqueous liquid form.

16. The unit-dose package of claim 12, wherein the laundry or dishwashing detergent is provided as a non-mixing form selected from the group consisting of a solid, a gel, a paste, or a wax.

17. The unit-dose package of claim 12, wherein the laundry or dishwashing detergent is provided as a very low-water liquid having a water content of less than about 10%.

18. The unit-dose package of claim 12, wherein the laundry or dishwashing detergent is non-aqueous.

19. The unit-dose package of claim 1, wherein the first compartment is completely bounded by a water-soluble material.

20. The unit-dose package of claim 1, wherein the second compartment is completely bounded by a water-soluble material.

21. The unit-dose package of any of claim 1, wherein the first compartment is the water-soluble material bounding the second compartment.

22. The unit-dose package of any of claim 1, wherein the second compartment is the water-soluble material at least partially bounding the first compartment.

23. The unit-dose package of any of claim 1, wherein the first compartment is a film applied to the water-soluble material bounding the second compartment.

24. The unit-dose package of any of claim 1, wherein the second compartment is a film applied to the water-soluble material bounding the first compartment.

25. The unit-dose package of any of claim 1, further comprising an additional compartment.

26. The unit-dose package of claim 25, wherein the additional compartment comprises a laundry detergent composition, a dishwashing detergent composition, a fabric softener, or a rinsing agent.

27. The unit-dose package of claim 1, wherein the peroxide source component is and oxidase enzyme and a substrate for the oxidase enzyme, wherein the activity of the oxidase enzyme on the substrate produces peroxide.

28. The unit-dose package of claim 27, wherein oxidase enzyme and substrate for the oxidase enzyme are present in different compartments.

29. A unit-dose package comprising a water-soluble pouch and a detergent composition, the pouch comprising at least a first compartment and a second compartment, the detergent composition comprising:
(a) from about 5% to about 80% by weight of a surfactant;
(b) from about 1% to about 15% by weight of non-aqueous solvent;
(c) less than 10% by weight of water; and
(d) a perhydrolase enzyme system comprising (i) a perhydrolase enzyme, (ii) an acyl substrate, and (iii) a peroxide source;
wherein at least one component selected from (i), (ii), or (iii) is separated from at least one other component selected from (i), (ii), or (iii) by being present in different compartments of the pouch.

30. The unit-dose package of claim 29, comprising at least a first compartment, a second compartment, and a third compartment, wherein each component selected from (i), (ii), or (iii) is separated from each other component by being present in a different compartment of the pouch.

31. The unit-dose package of claim 29 wherein the detergent composition further comprises an additional component selected from the group consisting of a chelant, a polymer, a brightener, a fragrance, and a process aid.

32. The unit-dose package of claim 29, wherein the detergent composition further comprises one or more additional enzymes other than the perhydrolase.

33. The unit-dose package of claim 29, wherein the surfactant is an anionic surfactant, a non-ionic surfactant, or combinations thereof.

34. A unit-dose package comprising a water-soluble pouch and a detergent composition, the pouch comprising at least a first compartment and a second compartment, the detergent composition comprising:
(a) a non-phosphorus builder;
(b) a chelating agent;
(c) a perhydrolase enzyme system comprising a perhydrolase enzyme, an acyl substrate, and a peroxide source;
wherein at least two components of the perhydrolase enzyme system are present in different compartments of the pouch.

35. The unit-dose package of claim 34 wherein the detergent composition further comprises a cleaning enzyme selected from the group consisting of a protease and an alpha-amylase.

36. The unit-dose package of claim 34 further comprising a rinse aid.


SEQUENCE LISTING (11 sequences)

SEQ ID NO: 1 - protein, 216 aa, M. smegmatis
  misc_feature: amino acid sequence of M. smegmatis perhydrolase
MAKRILCFGDSLTWGWVPVEDGAPTERFAPDVRWTGVLAQQLGADFEVIEEGLSARTTNIDDPTDPRLNGASYLPSCLATHLPLDLVIIMLGTNDTKAYFRRTPLDIALGMSVLVTQVLTSAGGVGTTYPAPKVLVVSPPPLAPMPHPWFQLIFEGGEQKTTELARVYSALASFMKVPFFDAGSVISTDGVDGIHFTEANNRDLGVALAEQVRSLL

SEQ ID NO: 2 - protein, 216 aa, Artificial Sequence
  S54V variant of the M. smegmatis perhydrolase
MAKRILCFGDSLTWGWVPVEDGAPTERFAPDVRWTGVLAQQLGADFEVIEEGLVARTTNIDDPTDPRLNGASYLPSCLATHLPLDLVIIMLGTNDTKAYFRRTPLDIALGMSVLVTQVLTSAGGVGTTYPAPKVLVVSPPPLAPMPHPWFQLIFEGGEQKTTELARVYSALASFMKVPFFDAGSVISTDGVDGIHFTEANNRDLGVALAEQVRSLL

SEQ ID NO: 3 - protein, 318 aa, Bacillus subtilis
  misc_feature: Cephalosporin C deacetylase from Bacillus subtilis ATCC 31954
MQLFDLPLDQLQTYKPEKTAPKDFSEFWKLSLEELAKVQAEPDLQPVDYPADGVKVYRLTYKSFGNARITGWYAVPDKQGPHPAIVKYHGYNASYDGEIHEMVNWALHGYAAFGMLVRGQQSSEDTSISLHGHALGWMTKGILDKDTYYYRGVYLDAVRALEVISSFDEVDETRIGVTGGSQGGGLTIAAAALSDIPKAAVADYPYLSNFERAIDVALEQPYLEINSFFRRNGSPETEVQAMKTLSYFDIMNLADRVKVPVLMSIGLIDKVTPPSTVFAAYNHLETEKELKVYRYFGHEYIPAFQTEKLAFFKQHLKG

SEQ ID NO: 4 - protein, 318 aa, Bacillus subtilis
  misc_feature: Cephalosporin C deacetylase from Bacillus subtilis subsp. subtilis str. 168 or Bacillus subtilis BE1010
MQLFDLPLDQLQTYKPEKTAPKDFSEFWKLSLEELAKVQAEPDLQPVDYPADGVKVYRLTYKSFGNARITGWYAVPDKEGPHPAIVKYHGYNASYDGEIHEMVNWALHGYATFGMLVRGQQSSEDTSISPHGHALGWMTKGILDKDTYYYRGVYLDAVRALEVISSFDEVDETRIGVTGGSQGGGLTIAAAALSDIPKAAVADYPYLSNFERAIDVALEQPYLEINSFFRRNGSPETEVQAMKTLSYFDIMNLADRVKVPVLMSIGLIDKVTPPSTVFAAYNHLETKKELKVYRYFGHEYIPAFQTEKLAFFKQHLKG

SEQ ID NO: 5 - protein, 318 aa, Bacillus subtilis
  misc_feature: Cephalosporin acetyl hydrolase (CAH) from Bacillus subtilis ATCC 6633
MQLFDLPLDQLQTYKPEKTTPNDFSEFWKSSLDELAKVKAAPDLQLVDYPADGVKVYRLTYKSFGNARITGWYAVPDKEGPHPAIVKYHGYNASYDGEIHEMVNWALHGYAAFGMLVRGQQSSEDTSISPHGHALGWMTKGILDKDTYYYRGVYLDAVRALEVISSFDEVDETRIGVTGGSQGGGLTIAAAALSDIPKAAVADYPYLSNFERAIDVALEQPYLEINSFFRRNGSPETEEKAMKTLSYFDIMNLADRVKVPVLMSIGLIDKVTPPSTVFAAYNHLETEKELKVYRYFGHEYIPAFQTEKLAFFKQHLKG

SEQ ID NO: 6 - protein, 318 aa, Bacillus licheniformis
  misc_feature: Cephalosporin C deacetylase from Bacillus licheniformis ATCC 14580
MQQPYDMPLEQLYQYKPERTAPADFKEFWKGSLEELANEKAGPQLEPHEYPADGVKVYWLTYRSIGGARIKGWYAVPDRQGPHPAIVKYHGYNASYDGDIHDIVNWALHGYAAFGMLVRGQNSSEDTEISHHGHVPGWMTKGILDPKTYYYRGVYLDAVRAVEVVSGFAEVDEKRIGVIGASQGGGLAVAVSALSDIPKAAVSEYPYLSNFQRAIDTAIDQPYLEINSFFRRNTSPDIEQAAMHTLSYFDVMNLAQLVKATVLMSIGLVDTITPPSTVFAAYNHLETDKEIKVYRYFGHEYIPPFQTEKLAFLRKHLK

SEQ ID NO: 7 - protein, 320 aa, Bacillus pumilus
  misc_feature: Acetyl xylan esterase from Bacillus pumilus PS213
MQLFDLSLEELKKYKPKKTARPDFSDFWKKSLEELRQVEAEPTLESYDYPVKGVKVYRLTYQSFGHSKIEGFYAVPDQTGPHPALVRFHGYNASYDGGIHDIVNWALHGYATFGMLVRGQGGSEDTSVTPGGHALGWMTKGILSKDTYYYRGVYLDAVRALEVIQSFPEVDEHRIGVIGGSQGGALAIAAAALSDIPKVVVADYPYLSNFERAVDVALEQPYLEINSYFRRNSDPKVEEKAFETLSYFDLINLAGWVKQPTLMAIGLIDKITPPSTVFAAYNHLETDKDLKVYRYFGHEFIPAFQTEKLSFLQKHLLLST

SEQ ID NO: 8 - protein, 320 aa, Clostridium thermocellum
  misc_feature: Acetyl xylan esterase from Clostridium thermocellum ATCC 27405
MAQLYDMPLEELKKYKPALTKQKDFDEFWEKSLKELAEIPLKYQLIPYDFPARRVKVFRVEYLGFKGANIEGWLAVPEGEGLYPGLVQFHGYNWAMDGCVPDVVNWALNGYAAFLMLVRGQQGRSVDNIVPGSGHALGWMSKGILSPEEYYYRGVYMDAVRAVEILASLPCVDESRIGVTGGSQGGGLALAVAALSGIPKVAAVHYPFLAHFERAIDVAPDGPYLEINEYLRRNSGEEIERQVKKTLSYFDIMNLAPRIKCRTWICTGLVDEITPPSTVFAVYNHLKCPKEISVFRYFGHEHMPGSVEIKLRILMDELNP

SEQ ID NO: 9 - protein, 320 aa, Thermotoga neapolitana
  misc_feature: Acetyl xylan esterase from Thermotoga neapolitana
MAFFDMPLEELKKYRPERYEEKDFDEFWRETLKESEGFPLDPVFEKVDFHLKTVETYDVTFSGYRGQRIKGWLLVPKLAEEKLPCVVQYIGYNGGRGFPHDWLFWPSMGYICFVMDTRGQGSGWMKGDTPDYPEGPVDPQYPGFMTRGILDPGTYYYRRVFVDAVRAVEAAISFPRVDSRKVVVAGGSQGGGIALAVSALSNRVKALLCDVPFLCHFRRAVQLVDTHPYVEITNFLKTHRDKEEIVFRTLSYFDGVNFAARAKVPALFSVGLMDTICPPSTVFAAYNHYAGPKEIRIYPYNNHEGGGSFQAIEQVKFLKR

SEQ ID NO: 10 - protein, 318 aa, Bacillus subtilis
  misc_feature: Cephalosporin C deacetylase from Bacillus subtilis ATCC 29233
MQLFDLPLDQLQTYKPEKTAPKDFSEFWKLSLEELAKVQAEPDLQPVDYPADGVKVYRLTYKSFGNARITGWYAVPDKQGPHPAIVKYHGYNASYDGEIHEMVNWALHGYAAFGMLVRGQQSSEDTSISPHGHALGWMTKGILDKDTYYYRGVYLDAVRALEVISSFDEVDETRIGVTGGSQGGGLTIAAAALSDIPKAAVADYPYLSNFERAIDVALEQPYLEINSFFRRNGSPETEVQAMKTLSYFDIMNLADRVKVPVLMSIGLIDKVTPPSTVFAAYNHLETEKELKVYRYFGHEYIPAFQTEKLAFFKQHLKG

SEQ ID NO: 11 - protein, 325 aa, Thermotoga maritima
  misc_feature: Acetyl xylan esterase from Thermotoga maritima
MAFFDLPLEELKKYRPERYEEKDFDEFWEETLAESEKFPLDPVFERMESHLKTVEAYDVTFSGYRGQRIKGWLLVPKLEEEKLPCVVQYIGYNGGRGFPHDWLFWPSMGYICFVMDTRGQGSGWLKGDTPDYPEGPVDPQYPGFMTRGILDPRTYYYRRVFTDAVRAVEAAASFPQVDQERIVIAGGSQGGGIALAVSALSKKAKALLCDVPFLCHFRRAVQLVDTHPYAEITNFLKTHRDKEEIVFRTLSYFDGVNFAARAKIPALFSVGLMDNICPPSTVFAAYNYYAGPKEIRIYPYNNHEGGGSFQAVEQVKFLKKLFEKG